(19) United States
(12) Patent Application Publication
(10) Pub. No.: US 2016/0244882 A1
(43) Pub. Date: Aug. 25, 2016

(54) METHOD FOR AUTOPHORETIC COATING OF METALLIC SUBSTRATES WITH AFTERTREATMENT OF THE COATING WITH AN AQUEOUS SOL-GEL COMPOSITION

(71) Applicant: BASF COATINGS GMBH, Münster (DE)

(72) Inventors: Sebastian SINNWELL, Duesseldorf (DE); Konstantinos MARKOU, Koeln (DE); Angelika TROLL, Duesseldorf (DE)

(73) Assignee: BASF COATINGS GMBH, Muenster (DE)

(21) Appl. No.: 15/026,157

(22) PCT Filed: Sep. 30, 2013
(86) PCT No.: PCT/EP13/70365

§ 371 Date: Mar. 30, 2016

(51) Int. Cl. C23C 18/12; C09D 183/04

(52) U.S. Cl. CPC C23C 18/1254; C09D 183/04

(57) ABSTRACT

The present invention relates to a method for at least partly coating a metallic substrate, at least comprising at least partly coating the substrate with an autophoretically depositable coating composition (step (1)) and contacting, with an aqueous sol-gel composition, the substrate at least partly coated with the autophoretically deposited coating composition (step (2)), to an at least partly coated substrate obtainable by this method, and to the use of an aqueous sol-gel composition for aftertreating a coating composition applied to a substrate at least partly by autophoretic deposition, by contacting the autophoretically deposited coating composition with the aqueous sol-gel composition.

The present invention relates to a method for at least partly coating a metallic substrate, at least comprising at least partly coating the substrate with an autophoretically depositable coating composition (step (1)) and contacting, with an aqueous sol-gel composition, the substrate at least partly coated with the autophoretically deposited coating composition (step (2)), to an at least partly coated substrate obtainable by this method, and to the use of an aqueous sol-gel composition for aftertreating a coating composition applied to a substrate at least partly by autophoretic deposition, by contacting the autophoretically deposited coating composition with the aqueous sol-gel composition.

In the automobile sector it is necessary for the metallic components used in the manufacture to be protected customarily against corrosion. The requirements in terms of the corrosion control to be achieved are very high, especially since the manufacturers often give a guarantee against rust perforation over many years. Corrosion control of this kind is achieved customarily through the coating of the components, or of the substrates used to produce them, with at least one coating suitable for the purpose.

Within the automobile industry, customarily, a coating of this kind is applied by electrodeposition coating the metallic components or bodies used. A disadvantage of such a process, however, is that it requires electrical energy. Another disadvantage of such a process is that the substrates used must customarily be subjected to an inorganic pretreatment in order to ensure adequate corrosion control. It is usual, for example, to insert a preliminary phosphating step as a pretreatment of this kind for electrodeposition coating, where the substrate to be coated, after an optional cleaning step and before a deposition coating step, is treated with a metal phosphate such as zinc phosphate in order to ensure adequate corrosion control. This pretreatment customarily involves the performance of a plurality of process steps in a plurality of different, and differently heated, coating tanks. Moreover, the performance of such a pretreatment produces waste slurries which burden the environment and have to be disposed of. It is therefore desirable, particularly for economic and environmental reasons, to be able to forgo such a pretreatment step, and yet still to achieve at least the same corrosion control effect which is achieved with the known processes. It is desirable, moreover, on economic grounds in particular to be able to do without the use of electrical energy and hence without the electrodeposition coating per se.

Processes which allow electroless and self-depositing coating, i.e., autophoretic coating, of various metallic substrates without application of an external voltage are already known in the prior art, as for example from US 2004/043155 A1, EP 0 716 627 B1, WO 2008/036259 A1, WO 2011/029680 A1, and WO 2012/174424 A1. In comparison with electrodeposition coating, therefore, these processes offer the advantage in particular of a procedure which is less expensive and is easier to carry out, and also of a shorter process duration.

Autophoretic coating is customarily followed by an aftertreatment of the deposited autophoretic coating with an aqueous solution in order to allow adequate corrosion control to be ensured. From European patent EP 0 716 627 B1 and also from WO 2011/029680 A1, an aftertreatment rinse of this kind is known with an aqueous solution which comprises hexafluorozirconic acid or a corresponding salt of said acid. A disadvantage of such aqueous solutions, however, particularly on environmental grounds, is their fluoride content. Moreover, the autophoretically coated substrates aftertreated with an aqueous, hexafluorozirconic acid-containing solution of this kind oftentimes fail to satisfy the requirement of adequate corrosion control.

There is therefore a need for a method for at least partly coating a metallic substrate that can be carried out more economically and environmentally than the known processes, and yet is suitable at least to the same extent for achieving the required corrosion control effect.

It is an object of the present invention, therefore, to provide a method for at least partly coating a metallic substrate that has advantages over the process known from the prior art. More particularly it is an object of the present invention to provide a method of this kind which instead of electrodeposition coating permits autophoretic deposition of the coating composition used accordingly, but with which the corrosion control effect achievable is at least equal to, and preferably an improvement on, that of autophoretic deposition processes known from the prior art, the intention being that the method should also operate, on environmental considerations, without the use of a fluoride-containing rinse aftertreatment solution in particular.

This object is achieved by the subject matter claimed in the claims and also by the preferred embodiments of that subject matter that are described in the description hereinafter.

A first subject of the present invention is therefore a method for at least partly coating a metallic substrate, comprising at least the steps of
(1) at least partly coating the substrate with an autophoretically depositable coating composition (I), and
(2) with an aqueous composition, contacting the substrate at least partly coated with the autophoretically deposited coating composition (I),
   wherein the aqueous composition used in step (2) is an aqueous sol-gel composition (II).

It has surprisingly been found that the method of the invention, relative to processes customarily used that provide for electrodeposition coating rather than autophoretic deposition, can be designed overall to be not only more economic, more particularly less time-consuming and cost-intensive, but also more environmental.

It has further surprisingly been found that at least partly coated substrates produced by the method of the invention, comprising at least step (1) and (2), in particular by virtue of the contacting as per step (2), nevertheless have at least no disadvantages, and more particularly have advantages, in terms of the corrosion control effect of the coatings in comparison to substrates obtained by conventional processes that do not provide for an inventive step (2): thus the coated substrates produced by the method of the invention, especially coated galvanized steels, are notable relative to corresponding comparative examples in particular for the fact that the undermining, as a measure of a corrosion control effect, is significantly less in the case of the coated substrates produced by the method of the invention, comprising, in particular, step (2). Here it has surprisingly been found in particular that an improved corrosion control effect of this kind can also be achieved relative to substrates coated at least partly by means of an autophoretic process that subsequent to such coating are aftertreated with a fluoride-containing solution.

It has additionally been surprisingly found, in particular, that with the aqueous sol-gel composition (II) used in accordance with the invention in step (2) of the method of the invention, more particularly with a sol-gel composition (II) having at least one reactive functional group, film formation can be achieved and, moreover, covalent bonds can be formed by reaction with reactive functional groups of suitable components present in the coating composition (I), such as binders and optionally crosslinking agents, something which is not achievable in the case of aftertreatment with—for example—aqueous solutions that are known from European patent EP 0 716 627 B1 and also from WO 2011/029680 A1 that comprise hexafluorozirconic acid or a corresponding salt of said acid.

The term “comprising” in the sense of the present invention, as for example in connection with the autophoretically depositable coating composition (I) used in accordance with the invention and with the aqueous sol-gel composition (II), has in one preferred embodiment the meaning of “consisting of”. With regard to the coating composition (I) used in accordance with the invention and to the aqueous sol-gel composition (II), in this preferred embodiment, there may be present in each case one or more of the further components identified below and optionally included in the respective composition employed in accordance with the invention. All of these components may be present in each case in their above-specified and below-specified preferred embodiments in the coating composition (I) used in accordance with the invention and/or in the aqueous sol-gel composition (II).

### Substrate

Suitability as metallic substrate used in accordance with the invention is possessed by all customarily employed metallic substrates that are known to the skilled person. The term “metallic” here embraces preferably metals and alloys. In one preferred embodiment the metallic substrate used in accordance with the invention is a substrate consisting entirely of metals and/or alloys. Those in question are preferably non-noble metals or alloys which are customarily used as metallic materials of construction and which require protection from corrosion. The substrates used in accordance with the invention are preferably selected from the group consisting of steel, preferably steel selected from the group consisting of cold-rolled steel, galvanized steel such as dip-galvanized steel, alloy-galvanized steel (such as Galvalume, Galvannealed or Galfan, for example) and aluminized steel, aluminum and magnesium, particular suitability being possessed by galvanized steel and aluminum. Further suitable substrates include hot-rolled steel, high-strength steel, Zn/Mg alloys, and Zn/Ni alloys. Especially suitable substrates are parts of bodies or complete bodies of automobiles for production. The method of the invention can also be used for coil coating. Before the substrate in question is used in the method of the invention, it is preferably cleaned and/or degreased.

The method of the invention is preferably a method for at least partly coating a metallic substrate, preferably an electrically conductive metallic substrate, that is used in and/or for automaking. The method may take place continuously, such as in a coil coating process, for example, or discontinuously.

The metallic substrate used in the method of the invention is an untreated substrate, i.e., a substrate which has not undergone any pretreatment step such as an inorganic pretreatment step, for example. More particularly the metallic substrate used in accordance with the invention is not a substrate pretreated with at least one metal phosphate, and not a substrate pretreated with an aqueous pretreatment composition (B) comprising at least one water-soluble compound (B1) which comprises at least one Ti atom and/or at least one Zr atom and at least one water-soluble compound (B2) as source of fluoride ions, comprising at least one fluorine atom, or with an aqueous pretreatment composition (B) comprising at least one water-soluble compound (B3) obtainable by reaction of at least one water-soluble compound that comprises at least one Ti atom and/or at least one Zr atom with at least one water-soluble compound as source of fluoride ions that comprises at least one fluorine atom.

### Step (1)

Step (1) of the method of the invention comprises at least partly coating the metallic substrate used with an autophoretically depositable coating composition (I).

Step (1) of the method of the invention is preferably carried out in a dip coating bath which contains the coating composition (I).

Preferably, in step (1) of the method of the invention, the substrate is coated completely with the autophoretically depositable coating composition (I) by autophoretic deposition of the coating composition (I) over the entire substrate surface.

Preferably, in step (1) of the method of the invention, a substrate for at least partial coating is introduced at least partly, preferably completely, into a dip coating bath and step (1) is carried out in this dip coating bath.

Step (1) of the method of the invention is carried out preferably at a dip bath temperature in a range from 20 to 45° C. or from 20° C. to 40° C., more preferably in a range from 22 to 40° C., very preferably in a range from 24 to 39° C., especially preferably in a range from 26 to 36° C., more particularly preferably in a range from 27 to 33° C. such as, for example, in a range from 28 to 32° C. In another preferred embodiment of the method of the invention, step (1) is carried out at a dip bath temperature of at most 40° C., more preferably at most 38° C., very preferably at most 35° C., especially preferably at most 34° C. or at most 33° C. or at most 32° C. or at most 31° C. or at most 30° C. or at most 29° C. or at most 28° C. In a further other preferred embodiment of the method of the invention, step (1) is carried out at a dip bath temperature ≦32° C. such as, for example, ≦31° C. or ≦30° C. or ≦29° C. or ≦28° C. or ≦27° C. or ≦26° C. or ≦25° C. or ≦24° C. or ≦23° C.

Step (1) is carried out preferably over a period in the range from 30 to 300 seconds, more preferably from 45 to 250 seconds, very preferably from 60 to 200 seconds.

In one particularly preferred embodiment step (1) takes place at a temperature in the range from 20 to 40° C. for a period in the range from 30 to 300 seconds. The temperature here is preferably the dip bath temperature.

The autophoretically depositable coating composition (I) is preferably applied in step (1) of the method of the invention in such a way that the resulting coating film has a dry film thickness in the range from 5 to 40 μm, more preferably from 10 to 30 μm.

### Autophoretically Depositable Coating Composition (I)

The autophoretically depositable coating composition (I) used in accordance with the invention is preferably an aqueous coating composition (I).

The coating composition (I) used in accordance with the invention is suitable for at least partly coating a metallic substrate with an autophoretically depositable deposition coating material, meaning that it is suitable for application at least partly in the form of a corresponding deposition coating film to the substrate surface of a metallic substrate.

The coating composition (I) used in accordance with the invention preferably comprises water as its liquid diluent.

The term “aqueous” in connection with the coating composition (I) used in accordance with the invention refers preferably to those liquid coating compositions which comprise—as their liquid diluent, i.e., as liquid solvent and/or dispersion medium—water as principal component. The coating compositions in question, however, may optionally include at least one organic solvent in small proportions. Examples of such organic solvents will include heterocyclic, aliphatic or aromatic hydrocarbons, mono- or polyhydric alcohols, more particularly methanol and/or ethanol and/or butanol, ethers, esters, ketones, and amides, such as N-methylpyrrolidone, N-ethylpyrrolidone, dimethyl-formamide, toluene, xylene, butanol, ethyl and butyl glycol and also their acetates, butyl diglycol, diethylene glycol dimethyl ether, cyclohexanone, methyl ethyl ketone, methyl isobutyl ketone, acetone, isophorone, or mixtures thereof. The proportion of these organic solvents is preferably at most 20.0 wt %, more preferably at most 15.0 wt %, very preferably at most 10.0 wt %, more particularly at most 5.0 wt %, or at most 4.0 wt % or at most 3.0 wt %, more preferably still at most 2.5 wt % or at most 2.0 wt % or at most 1.5 wt %, most preferably at most 1.0 wt % or at most 0.5 wt %, based in each case on the total proportion of the liquid diluents, i.e., liquid solvents and/or dispersion media, present in the coating composition (I).

The proportions in wt % of all of the components present in the coating composition (I) used in accordance with the invention add up preferably to 100 wt %, based on the total weight of the coating composition (I).

The coating composition (I) used in accordance with the invention preferably has a solids content in the range from 0.5 to 15 wt %, more preferably in the range from 1 to 12 wt %, very preferably from 1.5 to 10 wt %, more preferably still in the range from 2 to 9 wt % or in the range from 2 to 8 wt %, more preferably from 3 to 7 wt %, based in each case on the total weight of the coating composition (I) used in accordance with the invention. Methods for determining the solids content are known to the skilled person. The solids content is determined preferably in accordance with DIN EN ISO 3251 (date: Jun. 1, 2008).

The coating composition (I) used in accordance with the invention is preferably an aqueous solution or dispersion of at least one autophoretically depositable binder and optionally at least one crosslinking agent.

The term “binder” as a constituent of the coating composition (I) encompasses in the sense of the present invention preferably the autophoretically depositable polymeric resins of the coating composition (I) that are responsible for forming the film, although any crosslinking agent present is not included in the concept of the binder. A “binder” in the sense of the present invention, therefore, is preferably a polymeric resin, although any crosslinking agent present is not included in the concept of the binder. In particular, moreover, any pigments and fillers present are not subsumed by the term “binder”.

The at least one autophoretically depositable binder is preferably a binder which is dispersible or soluble in water, i.e., a water-soluble or -dispersible polymeric resin.

Used preferably for preparing the coating composition (I), as autophoretically depositable binder and crosslinking agent optionally present, is an aqueous dispersion or solution, preferably dispersion, of the at least one binder and of the at least one crosslinking agent where present, this solution or dispersion having a solids content in the range from 5 to 60 wt %, more preferably in the range from 10 to 55 wt %, very preferably from 15 to 50 wt %, more preferably still in the range from 20 to 45 wt % or in the range from 25 to 40 wt %, more particularly from 30 to 40 wt %, based in each case on the total weight of this aqueous solution or dispersion used in accordance with the invention. Methods for determining the solids content are known to the skilled person. The solids content is determined preferably in accordance with DIN EN ISO 3251 (date: Jun. 1, 2008).

Suitable binder components of the coating composition (I) include all customary autophoretically depositable binders known to the skilled person.

The coating composition (I) used in accordance with the invention preferably comprises at least one binder which has reactive functional groups which enable a crosslinking reaction. The binder here is a self-crosslinking or an externally crosslinking binder, preferably an externally crosslinking binder. In order to enable a crosslinking reaction, therefore, the coating composition (I) used in accordance with the invention comprises not only the at least one binder but also, preferably, at least one crosslinking agent.

Any customary crosslinkable reactive functional group known to the skilled person is contemplated here. The binder preferably has reactive functional groups selected from the group consisting of hydroxyl groups, thiol groups, carboxyl groups, groups which have at least one C═C double bond, such as vinyl groups or (meth)acrylate groups, for example, and epoxide groups. Especially preferred are hydroxyl groups, carboxyl groups and/or epoxide groups.

The expression “(meth)acrylic” or “(meth)acrylate” in the sense of the present invention encompasses in each case the definitions “methacrylic” and/or “acrylic” and, respectively, “methacrylate” and/or “acrylate”.

The binder present in the coating composition (I) used in accordance with the invention, and the crosslinking agent optionally present, are preferably crosslinkable thermally and/or crosslinkable by radiation curing, as for example using UV radiation. The binder and the optionally present crosslinking agent are preferably crosslinkable on heating to temperatures above room temperature, i.e., above 18-23° C. The binder and the optionally present crosslinking agent are preferably crosslinkable only at oven temperatures ≧80° C., more preferably ≧110° C., very preferably ≧130° C., and especially preferably ≧140° C. With particular advantage the binder and the optionally present crosslinking agent are crosslinkable at 100 to 250° C., more preferably at 125 to 250° C., and very preferably at 150 to 250° C.

Autophoretically depositable coating compositions and binders are known to the skilled person, from—for example—US 2004/043155 A1, EP 0 716 627 B1, WO 2008/036259 A1, WO 2011/029680 A1, and WO 2012/174424 A1.

The binder used in the coating composition (I) used in accordance with the invention is preferably at least one polymeric resin selected from the group consisting of epoxide-based resins, styrene-butadiene-based resins, acrylonitrile-butadiene-based resins, polyolefins, especially polyethylene, (meth)acrylic-based resins, polyvinyl chloride, styrene-acrylate-based resins, styrene-epoxide-based resins, polyurethanes, styrene-epoxide-acrylic-based resins, and polymeric resins based on tetrafluoroethylene. Especially preferred is a styrene-epoxide-acrylic-based polymeric resin.

The binder used in the coating composition (I) used in accordance with the invention is preferably an anionically stabilized binder.

The binder used in the coating composition (I) used in accordance with the invention is preferably a copolymer and/or polymer mixture which is obtainable by copolymerization, preferably emulsion copolymerization, of at least one ethylenically unsaturated monomer in the presence of at least one polymeric epoxy resin or at least one polymeric epoxide-based resin.

With particular preference the binder used in the coating composition (I) used in accordance with the invention is a copolymer and/or polymer mixture which is obtainable by copolymerization, preferably emulsion copolymerization, of at least one monomer having at least one vinyl group and of at least one alkyl (meth)acrylate monomer optionally having at least one functional group that is reactive toward an isocyanate group, such as an OH group, for example, more particularly of at least one alkyl (meth)acrylate monomer having at least one OH group and of at least one alkyl (meth)acrylate monomer which has an unsubstituted alkyl radical, and also, optionally, of at least one further monomer (M1) which is different from the abovementioned monomers, in the presence of at least one polymeric epoxy resin or at least one polymeric epoxide-based resin.

Alkyl (meth)acrylate monomers in this respect are preferably alkyl (meth)acrylates of unbranched or branched aliphatic alcohols having 1 to 22, preferably 1 to 12, carbon atoms, such as, for example, methyl (meth)acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate, stearyl (meth)acrylate, it being possible for the alkyl radicals of these (meth)acrylates in each case optionally to have at least one OH group. Examples of such alkyl (meth)acrylates having at least one OH group are, in particular, hydroxyethyl (meth)acrylate, hydroxypropyl (meth)acrylate, and hydroxybutyl (meth)acrylate.

Monomers having at least one vinyl group in this respect are selected more particularly from the group consisting of styrene and substituted styrenes, preferably alpha-methylstyrene and/or 4-methylstyrene; preferably nonbasic, cycloaliphatic heterocyclic compounds having vinyl groups and at least one N atom as ring member, such as N-vinylpyrrolidone and/or N-vinylcaprolactam, for example; preferably nonbasic, heteroaromatic compounds having vinyl groups and at least one N atom as ring member, such as 4-vinylpyridine, 2-vinylpyridine or vinylimidazole, for example, and vinyl esters of monocarboxylic acids, preferably of monocarboxylic acids having 1 to 20 carbon atoms, such as vinyl acetate, for example.

The further monomer (M1) here is preferably selected from the group consisting of cycloalkyl (meth)acrylates, aryl (meth)acrylates, alkylaryl (meth)acrylates, alkyl(meth)acrylamides, cyclo-alkyl(meth)acrylamides, aryl(meth)acrylamides, alkyl-aryl(meth)acrylamides, (meth)acrylonitrile, (meth)acrylic acid, and also allyl alcohol, vinyl alcohol, hydroxyalkyl vinyl ethers, and hydroxyalkyl allyl ethers.

Cycloalkyl (meth)acrylates in this respect are preferably cycloalkyl (meth)acrylates of cycloaliphatic alcohols having 3 to 22, preferably 3 to 12, carbon atoms, such as, for example, cyclohexyl (meth)acrylate or isobornyl (meth)acrylate.

Aryl (meth)acrylates in this respect are preferably aryl (meth)acrylates of aromatic alcohols having 6 to 22, preferably 6 to 12, carbon atoms, it being possible for the aryl radicals in each case to be unsubstituted or substituted up to four times, such as 4-nitrophenyl methacrylate or phenyl (meth)acrylate, for example.

Alkylaryl (meth)acrylates in this respect are preferably alkylaryl (meth)acrylates of alcohols having 6 to 22, preferably 6 to 12, carbon atoms, having both an aliphatic and an aromatic radical, it being possible for the aryl radicals in each case to be unsubstituted or substituted up to four times, such as benzyl (meth)acrylate, for example.

With more particular preference the binder used in the coating composition (I) used in accordance with the invention is a copolymer and/or polymer mixture which is obtainable by copolymerization, preferably emulsion copolymerization, of styrene, at least one alkyl (meth)acrylate monomer having at least one OH group, at least one alkyl (meth)acrylate monomer which has an unsubstituted alkyl radical, and at least one further monomer (M1) which is preferably selected from the group consisting of cycloalkyl (meth)acrylates and (meth)acrylic acid, in the presence of at least one polymeric epoxy resin and/or at least one polymeric epoxide-based resin.

By epoxide-based resins and/or epoxy resins are meant preferably polyepoxides having two or more epoxide groups. Particularly preferred polyepoxides here are polyglycidyl ethers of polyphenols that are prepared from polyphenols and epihalohydrins. As polyphenols it is possible in particular to use bisphenol A and/or bisphenol F. Further suitable polyepoxides are polyglycidyl ethers of polyhydric alcohols, such as ethylene glycol, diethylene glycol, triethylene glycol, 1,2-propylene glycol, 1-4-propylene glycol, 1,5-pentanediol, 1,2,6-hexanetriol, glycerol, and 2,2-bis(4-hydroxycyclohexyl)propane.

The binder used in the coating composition (I) used in accordance with the invention is preferably obtainable by
(a) mixing at least one epoxide-based resin and/or epoxy resin with at least one ethylenically unsaturated monomer,
(b) dispersing the mixture of step (a) in water with at least one surface-active compound so as to form a fine dispersion, and
(c) (co)polymerizing the at least one ethylenically unsaturated monomer, in the presence of the at least one epoxide-based resin and/or epoxy resin,
   where at least one water-soluble initiator and/or at least one organically soluble initiator, more preferably at least one water-soluble initiator, is added before step (c) and where preferably at least one preferably latent crosslinking agent, more preferably at least one blocked isocyanate, is incorporated into the mixture before the at least one ethylenically unsaturated monomer is polymerized.

Added preferably before step (c) is at least one further component selected from the group consisting of crosslinking agents, coalescents, flow control agents, chain transfer agents, and mixtures thereof.

As initiator it is possible to use any customary compound suitable for this purpose and known to the skilled person. Initiators of these kinds are known to the skilled person, from US 2004/043155 A1, for example. Employed with preference as at least one water-soluble initiator is tert-butyl hydroperoxide. Preference is given to using tert-butyl hydroperoxide in combination with at least one reducing agent, more particularly sodium formaldehyde-sulfoxylate.

As surface-active compound it is possible to use any customary compound suitable for the purpose that is known to the skilled person. The skilled person is aware of such surface-active compounds from US 2004/043155 A1, for example. Preference is given to selecting at least one surface-active compound from the group consisting of amphoteric, nonionic, and anionic surface-active compounds and also mixtures thereof, with particular preference being given to anionic surface-active compounds. Particularly preferred anionic surface-active compounds are sodium allyloxyhydroxypropylsulfonate and optionally propenyl-modified nonylphenol ethoxylate sulfate and optionally propenyl-modified nonylphenol ethoxylate sulfonate.

Besides the at least one autophoretically depositable binder, the inventively employed coating composition (I) optionally comprises at least one preferably autophoretically depositable crosslinking agent which permits a crosslinking reaction with the reactive functional groups of the binder.

All customary crosslinking agents known to the skilled person may be used, such as phenolic resins, polyfunctional Mannich bases, melamine resins, benzoguanamine resins, epoxides and/or blocked polyisocyanates, for example, particularly blocked polyisocyanates.

A particularly preferred crosslinking agent is a blocked (poly)isocyanate which can be used optionally in combination with a phenolic resin. Blocked polyisocyanates which can be utilized are any polyisocyanates such as diisocyanates, for example, in which the isocyanate groups have been reacted with a compound and so the blocked polyisocyanate formed is stable in particular with respect to hydroxyl and amino groups, such as primary and/or secondary amino groups, at room temperature, i.e., at a temperature of 18 to 23° C., but reacts at elevated temperatures, as for example at ≧80° C., more preferably ≧110° C., very preferably ≧130° C., and especially preferably ≧140° C., or at 90° C. to 300° C. or at 100 to 250° C., more preferably at 125 to 250° C., and very preferably at 150 to 250° C.

In the preparation of the blocked polyisocyanates it is possible to use any desired organic polyisocyanates that are suitable for crosslinking. Isocyanates used are preferably (hetero)aliphatic, (hetero)-cycloaliphatic, (hetero)aromatic, or (hetero)aliphatic-(hetero)aromatic isocyanates. Preferred are diisocyanates which contain 2 to 36, more particularly 6 to 15, carbon atoms. Preferred examples are 1,2-ethylene diisocyanate, 1,4-tetramethylene diisocyanate, 1,6-hexamethylene diisocyanate (HDI), 2,2,4(2,4,4)-trimethyl-1,6-hexamethylene diisocyanate (TMDI), diphenylmethane diisocyanate (MDI), 1,9-diisocyanato-5-methylnonane, 1,8-diisocyanato-2,4-dimethyloctane, 1,12-dodecane diisocyanate, ω,ω′-diisocyanatodipropyl ether, cyclobutene 1,3-diisocyanate, cyclohexane 1,3- and 1,4-diisocyanate, 3-isocyanatomethyl-3,5,5-trimethylcyclohexyl isocyanate (isophorone diisocyanate, IPDI), 1,4-diisocyanatomethyl-2,3,5,6-tetramethylcyclohexane, decahydro-8-methyl-1,4-methanol-naphthalen-2 (or 3),5-ylenedimethylene diisocyanate, hexahydro-4,7-methano-indan-1 (or 2),5 (or 6)-ylenedimethylene diisocyanate, hexahydro-4,7-methanoindan-1 (or 2),5 (or 6)-ylene diisocyanate, 2,4- and/or 2,6-hexahydrotolylene diisocyanate (H6-TDI), 2,4- and/or 2,6-toluene diisocyanate (TDI), perhydro-2,4′-diphenylmethane diisocyanate, perhydro-4,4′-diphenylmethane diisocyanate (H₁₂MDI), 4,4′-diisocyanato-3,3′,5,5′-tetramethyldicyclohexylmethane, 4,4′-diisocyanato-2,2′,3,3′,5,5′,6,6′-octamethyldicyclohexyl-methane, ω,ω′-diisocyanato-1,4-diethylbenzene, 1,4-diisocyanatomethyl-2,3,5,6-tetramethylbenzene, 2-methyl-1,5-diisocyanatopentane (MPDI), 2-ethyl-1,4-diiso-cyanatobutane, 1,10-diisocyanatodecane, 1,5-diiso-cyanatohexane, 1,3-diisocyanatomethylcyclohexane, 1,4-diisocyanatomethylcyclohexane, 2,5(2,6)-bis(isocyanato-methyl)bicyclo[2.2.1]heptane (NBDI), and also any mixture of these compounds. Polyisocyanates of higher isocyanate functionality may also be used. Examples thereof are trimerized hexamethylene diisocyanate and trimerized isophorone diisocyanate. Furthermore, mixtures of polyisocyanates may also be utilized. The organic polyisocyanates contemplated as crosslinking agents for the invention may also be prepolymers, deriving, for example, from a polyol, including from a polyether polyol or a polyester polyol. Especially preferred are 4-toluene diisocyanate and/or 2,6-toluene diisocyanate (TDI) and/or isomer mixtures of 2,4-toluene diisocyanate and 2,6-toluene diisocyanate and/or diphenylmethane diisocyanate (MDI).

Used preferably for the blocking of polyisocyanates may be any desired suitable aliphatic, cycloaliphatic, or aromatic alkyl monoalcohols. Examples thereof are aliphatic alcohols, such as methyl, ethyl, chloroethyl, propyl, butyl, amyl, hexyl, heptyl, octyl, nonyl, 3,3,5-trimethylhexyl, decyl, and lauryl alcohol; cycloaliphatic alcohols such as cyclopentanol and cyclohexanol; aromatic alkyl alcohols, such as phenylcarbinol and methylphenylcarbinol, or aromatic alcohols such as phenol. Other suitable blocking agents are hydroxylamines, such as ethanolamine, oximes, such as methyl ethyl ketone oxime, acetone oxime, and cyclohexanone oxime, and amines, such as dibutylamine and diisopropylamine.

The relative weight ratio of the at least one binder to the at least one crosslinking agent in the inventively employed coating composition (I) is preferably in a range from 4:1 to 1.1:1, more preferably in a range from 3:1 to 1.1:1, very preferably in a range from 2.5:1 to 1.1:1, more particularly in a range from 2.1:1 to 1.1:1, based in each case on the solids fraction of the at least one binder and of the at least one crosslinking agent in the inventively employed coating composition (I).

In another preferred embodiment, the relative weight ratio of the at least one binder to the at least one crosslinking agent in the inventively employed coating composition (I) is in a range from 4:1 to 1.5:1, more preferably in a range from 3:1 to 1.5:1, very preferably in a range from 2.5:1 to 1.5:1, more particularly in a range from 2.1:1 to 1.5:1, based in each case on the solids fraction of the at least one binder and of the at least one crosslinking agent in the inventively employed coating composition (I). Depending on desired application, moreover, the inventively employed coating composition (I) may comprise at least one pigment.

A pigment of this kind, present in the coating composition (I) inventively employed, is preferably selected from the group consisting of organic and inorganic, color-imparting and extending pigments.

Examples of suitable inorganic color-imparting pigments are white pigments such as zinc oxide, zinc sulfide, titanium dioxide, antimony oxide, or lithopone; black pigments such as carbon black, iron manganese black, or spinel black; chromatic pigments such as cobalt green or ultramarine green, cobalt blue, ultramarine blue or manganese blue, ultramarine violet or cobalt violet and manganese violet, red iron oxide, molybdate red, or ultramarine red; brown iron oxide, mixed brown, spinel phases and corundum phases; or yellow iron oxide, nickel titanium yellow, or bismuth vanadate. Examples of suitable organic color-imparting pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments, or aniline black. Examples of suitable extending pigments or fillers are chalk, calcium sulfate, barium sulfate, silicates such as talc or kaolin, silicas, oxides such as aluminum hydroxide or magnesium hydroxide, or organic fillers such as textile fibers, cellulose fibers, polyethylene fibers, or polymer powders; for further details, refer to Römpp Lexikon Lacke und Druckfarben, Georg Thieme Verlag, 1998, pages 250 ff., “Fillers”.

The pigment content of the coating compositions (I) inventively employed may vary according to intended use and according to the nature of the pigments. The relative weight ratio of pigments present in the inventively used coating composition (I) to the total solids content of the inventively used coating composition (I) is preferably in a range from 0.001:1 to 0.5:1, more preferably in a range from 0.005:1 to 0.4:1, very preferably in a range from 0.01:1 to 0.3:1.

Depending on desired application, the coating composition (I) inventively employed may comprise one or more typically employed additives. These additives are preferably selected from the group consisting of wetting agents, emulsifiers, dispersants, surface-active compounds such as surfactants, flow control assistants, solubilizers, defoamers, rheological assistants, antioxidants, stabilizers, preferably heat stabilizers, in-process stabilizers, and UV and/or light stabilizers, catalysts, fillers, waxes, flexibilizers, plasticizers, and mixtures of the abovementioned additives. The additive content may vary very widely according to intended use. The amount, based on the total weight of the coating composition (I) inventively employed, is preferably 0.1 to 20.0 wt %, more preferably 0.1 to 15.0 wt %, very preferably 0.1 to 10.0 wt %, especially preferably 0.1 to 5.0 wt %, and more particularly 0.1 to 2.5 wt %.

### Steps (1a) and (1b)

In one preferred embodiment, the process of the invention further comprises a step (1a), which preferably follows step (1) but is carried out before step (2), namely
(1a) rinsing the substrate obtainable by step (1), at least partly coated with the autophoretically deposited coating composition (I), with water and/or with ultrafiltrate.

The term “ultrafiltrate” or “ultrafiltration”, especially in connection with deposition coating, is known to the skilled person and defined for example in Römpp Lexikon, Lacke und Druckfarben, Georg Thieme Verlag 1998.

The implementation of step (1a) allows the recycling of excess constituents of the coating composition (I), present on the at least partly coated substrate after step (1), into the dip coating bath.

The process of the invention may further comprise an optional step (1b), which preferably follows step (1) or (1a), more preferably step (1a), but is carried out before step (2), namely
(1b) contacting the substrate obtainable by step (1) or step (1a), preferably by step (1a), and at least partly coated with the autophoretically deposited coating composition (I), with water and/or ultrafiltrate, preferably for a time of 30 seconds up to one hour, more preferably for a time of 30 seconds up to 30 minutes.

### Step (2)

Step (2) of the process of the invention comprises contacting the substrate coated at least partly with the autophoretically deposited coating composition (I) with an aqueous sol-gel composition (II).

The implementation of step (2) within the process of the invention takes place preferably prior to curing of the autophoretically deposited coating composition.

Step (2) therefore envisages an aftertreatment of the substrate coated at least partly with the autophoretically deposited coating composition (I), with an aqueous sol-gel composition (II).

The concept of “contacting” in the sense of the present invention refers preferably to immersion of the substrate coated at least partly with the autophoretically deposited coating composition (I) into the sol-gel composition (II) used in step (2), spraying or squirting of the substrate coated at least partly with the autophoretically deposited coating composition (I) with the aqueous sol-gel composition (I) with the aqueous sol-gel composition (II) used in step (2), or roller application of the aqueous sol-gel composition (II) used in step (2) to the substrate coated at least partly with the autophoretically deposited coating composition (I). More particularly the term “contacting” in the sense of the present invention will refer to immersing of the substrate coated at least partly with the autophoretically deposited coating composition (I) into the aqueous sol-gel composition (II) used in step (2).

Step (2) of the process of the invention is carried out preferably after step (1) or after steps (1), (1a), and (1b). If the process of the invention further comprises a step (1a), which preferably follows step (1) but is carried out before step (2), then step (2) sees the contacting of the substrate coated at least partly with the autophoretically deposited coating composition (I), as obtainable by step (1) and treated by means of rinsing by step (1a), with the aqueous sol-gel composition (II).

The aqueous sol-gel composition used in step (2) of the process of the invention preferably has a temperature in the range from 8° C. to 80° C., more preferably in the range from 10° C. to 75° C., more preferably in the range from 12° C. to 70° C., and very preferably in the range from 14° C. to 68° C., more particularly in the range from 15° C. to 66° C. or in the range from 15° C. to 64° C., more preferably in the range from 17° C. to 62° C., most preferably in the range from 18° C. to 60° C. In another preferred embodiment, the aqueous sol-gel composition used in step (2) of the process of the invention has a temperature in a range from 20° C. to 80° C., more preferably in the range from 30° C. to 75° C., very preferably in the range from 40° C. to 70° C., especially in the range from 50° C. to 65° C.

The duration of the contacting as per step (2) of the process of the invention is preferably in the range from 5 to 1000 seconds, more preferably in the range from 10 to 800 seconds, very preferably in the range from 10 to 600 seconds, more preferably in the range from 10 to 500 seconds.

In another preferred embodiment, the contacting as per step (2) of the process of the invention takes place for a time of at least 5 seconds, preferably of at least 10 seconds, more preferably of at least 15 seconds, more particularly of at least 20 seconds, most preferably of at least 25 seconds.

The composition used in step (2) of the process of the invention is an aqueous sol-gel composition (II).

The term “aqueous” in connection with the aqueous composition, or aqueous sol-gel composition (II), used in step (2) of the process of the invention refers preferably to a liquid composition which comprises water as the main component, as liquid diluent, i.e., as liquid solvent and/or dispersion medium, more particularly as solvent. Optionally, however, the aqueous composition inventively employed may further include a fraction of at least one organic solvent, preferably of at least one water-miscible organic solvent. Especially preferred are those preferably water-soluble organic solvents selected from the group consisting of alcohols such as methanol, ethanol, 1-propanol, and 2-propanol, organic carboxylic acids such as formic acid, acetic acid, propionic acid, ketones such as acetone, and glycols such as ethylene glycol or propylene glycol, and also mixtures thereof. The fraction of these preferably water-miscible organic solvents is preferably not more than 20.0 wt %, more preferably not more than 15.0 wt %, very preferably not more than 10.0 wt %, more particularly not more than 5.0 wt %, more preferably still not more than 2.5 wt %, most preferably not more than 1.0 wt %, based in each case on the total fraction of the liquid diluents, i.e., liquid solvents and/or dispersion media, more particularly solvents, that are present in the aqueous composition used in step (2) of the process of the invention.

The aqueous composition used in step (2) of the process of the invention is preferably in the form of an aqueous solution or aqueous dispersion, more particularly in the form of an aqueous solution. With particular preference, aqueous sol-gel composition (II) inventively employed is in the form of an aqueous colloidal solution or aqueous dispersion, more particularly in the form of aqueous colloidal solution.

The aqueous sol-gel composition (II) used in step (2) of the process of the invention preferably has a pH in the range from 2.0 to 10.0, more preferably in the range from 2.5 to 8.5 or in the range from 2.5 to 8.0, very preferably in the range from 3.0 to 7.0 or in the range from 3.0 to 6.5 or in the range from 3.0 to 6.0, more particularly in the range from 3.5 to 6.0 or in the range from 3.5 to 5.5, especially preferably in the range from 3.7 to 5.5, most preferably in the range from 3.9 to 5.5 or 4.0 to 5.5. Methods for adjusting pH values in aqueous compositions are known to the skilled person. The desired pH of the aqueous composition used in step (2) of the process of the invention is set preferably by addition of at least one acid, more preferably of at least one inorganic and/or at least one organic acid. Suitable inorganic acids are, for example, hydrochloric acid, sulfuric acid, phosphoric acid and/or nitric acid. A suitable organic acid is, for example, propionic acid, lactic acid, acetic acid and/or formic acid. Very preferably the desired pH is set by addition of formic acid or phosphoric acid.

### Aqueous Sol-Gel Composition (II)

The aqueous composition used in step (2) of the process of the invention is an aqueous sol-gel composition (II).

The skilled person is aware of the terms “sol-gel composition”, “sol-gel”, and also of the preparation of sol-gel compositions and sol-gels, from D. Wang et al., Progress in Organic Coatings 2009, 64, 327-338 or S. Zheng et al., J. Sol-Gel. Sci. Technol. 2010, 54, 174-187, for example.

An aqueous “sol-gel composition” in the sense of the present invention means preferably an aqueous composition prepared by reacting—with hydrolysis and condensation—at least one starting compound, which has at least one metal atom and/or semimetal atom such as M¹ and/or M², for example, and has at least two hydrolyzable groups such as two hydrolyzable groups X¹, for example, and which additionally optionally has at least one nonhydrolyzable organic radical such as R¹, for example, with water. The at least two hydrolyzable groups here are preferably each bonded directly to the at least one metal atom and/or at least one semimetal atom present in the at least one starting compound, in each case by means of a single bond. Because of the presence of the nonhydrolyzable organic radical such as R¹, for example, an inventively employed sol-gel composition of this kind may also be referred to as a “hybrid sol-gel composition”.

In the course of this reaction, in a first hydrolysis step, the at least two hydrolyzable groups are eliminated and are replaced within the at least one starting compound by OH groups, thus resulting in the formation of metal-OH bonds or semimetal-OH bonds within the at least one starting compound used in the first step (hydrolysis step). In a second step, there is a condensation of two molecules formed in the first step, by reaction, for example, of one of the metal-OH bonds thus formed in one molecule with one of the metal-OH bonds thus formed in the second molecule, with elimination of water (condensation step). The resulting molecule, having for example at least one metal-O-metal group (or metal-O-semimetal group or semimetal-O-semimetal group) and also a total of at least two hydrolyzable groups, can then be hydrolyzed again and can react analogously with further compounds obtainable in accordance with the first hydrolysis step, with the resulting compound formed analogously being then able to continue reacting correspondingly, leading to the formation of chains and, in particular, of two- or three-dimensional structures. This at least two-step process, comprising at least the first hydrolysis step and at least the second condensation step, is referred to as a sol-gel process or sol-gel technique. Depending on the degree of crosslinking as a result of the condensation, the product is a sol or a gel, and consequently the aqueous composition is referred to as a sol-gel composition. A pure sol composition here means preferably a composition in which the reaction products are present in colloidal solution. A sol composition is characterized by a lower viscosity than a gel composition. A pure gel composition means preferably a composition which is distinguished by a high viscosity and which has a gel structure. The transition from a sol composition to a gel composition is marked preferably by an abrupt increase in the viscosity. The inventively employed sol-gel composition is preferably neither a pure sol composition nor a pure gel composition, but instead a sol-gel composition.

The at least one starting compound needed for preparing the aqueous sol-gel composition (II) used in accordance with the invention is here prepared preferably by stirred incorporation into water of, or addition of water to, the at least one starting compound. This takes place preferably at a temperature which is in the range from 15° C. to 40° C. or in the range from 15° C. to 37° C., more preferably in the range from 17° C. to 35° C., most preferably in the range from 18° C. to 30° C. or in the range from 18° C. to 25° C. To accelerate the preparation of the aqueous sol-gel composition (II) used in accordance with the invention, the preparation may optionally also take place at temperatures higher than 40° C., as for example at a temperature of up to 80° C., i.e., for example, in a range from 15° C. to 80° C.

The aqueous sol-gel composition (II) thus obtained is preferably left to rest, before being used in step (2) of the process of the invention, for a time in the range from 2 hours to 28 days, more preferably for a time in the range from 3 hours to 26 days, very preferably for a time in the range from 5 hours to 22 days or for a time in the range from 6 hours to 20 days, more preferably still for a time in the range from 7 hours to 18 days, more particularly for a time in the range from 8 hours to 16 days, at a temperature of 18-25° C., in order to ensure sufficient hydrolysis and condensation. In another preferred embodiment, the aqueous sol-gel composition (II) thus obtained is left to rest, before being used in step (2) of the process of the invention, for a time of at least 4 hours, preferably of at least 6 hours or of at least 8 hours or of at least 12 hours or of at least 16 hours or of at least 20 hours or of at least 24 hours, more preferably for a time of at least 2 days or at least 3 days or at least 4 days or at least 6 days or at least 8 days or at least 10 days or at least 12 days or at least 14 days, at a temperature of 18-25° C., in order to ensure sufficient hydrolysis and condensation.

The at least one starting compound used in preparing the aqueous sol-gel composition (II), and having at least one metal atom and/or semimetal atom such as M¹ and/or M², for example, and at least two hydrolyzable groups such as at least two hydrolyzable groups X¹, for example, preferably also has at least one nonhydrolyzable organic radical. This nonhydrolyzable organic radical, such as a corresponding radical R¹, for example, is preferably bonded directly to the metal atom and/or semimetal atom present in the at least one starting compound, such as M¹ and/or M², for example, by means of a single bond. In this case, during the at least two-step process comprising at least the first hydrolysis step and at least the second condensation step, chains are formed, and more particularly two- or three-dimensional structures are formed, which have both organic and inorganic groups. In this case, the resulting sol-gel composition may be referred to as an inorganic-organic hybrid sol-gel composition.

The at least one nonhydrolyzable organic radical, such as the radical R¹, for example, optionally comprises at least one reactive functional group which is preferably selected from the group consisting of primary amino groups, secondary amino groups, epoxide groups, thiol groups, isocyanate groups, phosphorus-containing groups such as phosphonate groups, silane groups, which may optionally in turn have at least one nonhydrolyzable organic radical which optionally has at least one reactive functional group, and groups which have an ethylenically unsaturated double bond, such as vinyl groups or (meth)acrylic groups, very preferably selected from the group consisting of primary amino groups, secondary amino groups, epoxide groups, thiol groups, and groups which have an ethylenically unsaturated double bond, such as vinyl groups or (meth)acrylic groups, more particularly selected from the group consisting of primary amino groups and epoxide groups. The epoxide group here may be converted by reaction with water into two hydroxyl groups, which are then able to act as reactive functional groups.

The expression “(meth)acrylic” in the sense of the present invention encompasses each of the definitions “methacrylic” and/or “acrylic”.

The expression “nonhydrolyzable organic radical which has at least one reactive functional group” is preferably understood, in connection with a nonhydrolyzable organic radical such as the radical R¹, for example, to mean in the sense of the present invention that the nonhydrolyzable organic radical has at least one such functional group that exhibits reactivity toward the reactive functional groups optionally present in the binder of the coating composition (I) inventively employed and/or toward the reactive functional groups of the crosslinking agent (C) optionally present in the coating composition (I) inventively employed. Through a reaction of corresponding functional groups, covalent bonds may be formed here.

However, the at least one nonhydrolyzable organic radical, such as the radical R¹, for example, need not necessarily have at least one reactive functional group, but may instead be a nonhydrolyzable organic radical which has no reactive functional group.

The expression “nonhydrolyzable organic radical which has no reactive functional group” is understood preferably in the sense of the present invention, in connection with a nonhydrolyzable organic radical such as the radical R¹, for example, to mean that the nonhydrolyzable organic radical has no such functional group that exhibits reactivity toward the reactive functional groups present optionally in the binder of the coating composition (I) inventively employed and/or toward the reactive functional groups of the crosslinking agent (C) optionally present in the coating composition (I) inventively employed.

A particular feature of a resulting aqueous sol-gel composition (II)—in which the at least one starting compound has not only the at least two hydrolyzable groups such as at least two hydrolyzable groups X¹, for example, but also at least one nonhydrolyzable organic radical such as R¹, for example—is that its preparation process does not give rise to the formation of a colloidal hydroxide or colloidal oxide, which is disclosed in EP 1 510 558 A1 or WO 03/090938 A1, for example, but instead gives rise to an organic-inorganic hybrid sol-gel composition, which can be applied more effectively to the coating composition (I) deposited autophoretically in step (1) process of the invention than can a colloidal hydroxide or colloidal oxide according to EP 1 510 558 A1 or WO 03/090938 A1.

The aqueous sol-gel composition (II) preferably has at least one and optionally at least one further nonhydrolyzable organic radical, different from the first, such as, for example, at least one nonhydrolyzable organic radical R¹, which is a C₁₋₁₀ aliphatic radical which has at least one hydroxyl group as at least one reactive functional group, and the other nonhydrolyzable organic radical, present optionally, is a C₁₋₁₀ aliphatic radical which has at least one primary amino group or at least one secondary amino group as at least one reactive functional group. Suitability for preparing an inventively employed aqueous sol-gel composition (II) of this kind is possessed by at least one and optionally two starting compounds different from one another, which are subjected to hydrolysis and condensation with water, with the at least one starting compound having a C₁₋₁₀ aliphatic radical as a nonhydrolyzable organic radical such as R¹, for example, which has at least one epoxide group as a reactive functional group and the other starting compound, present optionally, has at least one primary amino group or at least one secondary amino group as reactive functional group. The epoxide group of the nonhydrolyzable organic radical in this case is converted by reaction with water into a corresponding organic radical having an α,β-dihydroxy group.

In one preferred embodiment the aqueous sol-gel composition (II) is obtainable by reacting

at least two starting compounds, each independently of one another having at least one metal atom and/or semimetal atom such as M¹, for example, and also each independently of one another having at least two hydrolyzable groups such as at least two hydrolyzable groups X¹, for example,
where the at least two hydrolyzable groups are preferably each bonded directly by means of single bonds to the metal atom and/or semimetal atom present in each case in the at least two starting compounds,
   with water,
   where preferably at least one of the at least two starting compounds has not only the at least two hydrolyzable groups but also at least one nonhydrolyzable group, more preferably at least one nonhydrolyzable organic radical such as the radical R¹, for example, and this nonhydrolyzable group is, in particular, attached directly by means of a single bond to the metal atom and/or semimetal atom, such as M¹, that is present in the at least one starting compound, and optionally comprises at least one reactive functional group which is preferably selected from the group consisting of primary amino groups, secondary amino groups, epoxide groups, thiol groups, isocyanate groups, phosphorus-containing groups such as phosphonate groups, silane groups, which may optionally in turn have at least one nonhydrolyzable organic radical which optionally has at least one reactive functional group, and groups which have an ethylenically unsaturated double bond, such as vinyl groups or (meth)acrylic groups, is especially preferably selected from the group consisting of primary amino groups, secondary amino groups, epoxide groups, thiol groups, and groups which have an ethylenically unsaturated double bond, such as vinyl groups or (meth)acrylic groups, and is more particularly selected from the group consisting of primary amino groups and epoxide groups.

The aqueous sol-gel composition (II) used in step (2) of the process of the invention is preferably obtainable by reaction of at least one compound

(M¹)^{x}(X¹)ₐ(R¹), (A1)

and/or

(M²)^{y}(X²)_{b}(R²)(R³), (A2)

preferably of at least one compound (A1),
with water, where
   M¹ and M² each independently of one another are a metal atom or a semimetal atom, with preferably at least one of the variables M¹ and M², more preferably both of the variables M¹ and M², standing for Si,
   X¹ and X² each independently of one another are a hydrolyzable group,
   x is the valence of the metal atom or semimetal atom M¹, preferably in each case +3 or +4,
   y is the valence of the metal atom or semimetal atom M², preferably in each case +3 or +4,
   R¹ is X¹, a nonhydrolyzable organic radical,
      is (T)(M¹)^{x}(X¹)_{c} or is (U)[(M¹)^{x}(X¹)_{c}]₂, preferably a nonhydrolyzable organic radical,
   R² is a nonhydrolyzable organic radical,
   R³ is a nonhydrolyzable organic radical, is (T)(M¹)^{x}(X¹)_{c}, is (U)[(M¹)^{x}(X¹)_{c}]₂, is (V)(M²)^{y}(X²)_{d}(R²) or is (W)[(M²)^{y}(X²)_{d}(R²)]₂, preferably a nonhydrolyzable organic radical,
   a is x if R¹ is X¹ or
   a is x−1 if R¹ is a nonhydrolyzable organic radical, is (T)(M¹)^{x}(X¹)_{c} or is (U)[(M¹)^{x}(X¹)_{c}]₂, in each case subject to the proviso that a is at least 2,
   b is y−2,
      subject to the proviso that b is at least 2,
   T, U, V, and W in each case independently of one another are a radical which has 1 to 30 carbon atoms and may optionally have up to 10 heteroatoms and heteroatom groups selected from the group consisting of O, S, and N,
   c is x−1, preferably subject to the proviso that c is at least 2, and
   d is y−2, preferably subject to the proviso that d is at least 2,
      with water.

The skilled person is aware of the term “hydrolyzable group”. Any customary hydrolyzable group known to the skilled person, such as X¹ or X², for example, may serve as a constituent of the at least one starting compound used in preparing the aqueous sol-gel composition, more particularly of the at least one component (A1) and/or (A2).

A “hydrolyzable group”, such as the groups X¹ and X², for example, refers in the sense of the present invention preferably to a hydrolyzable group selected from the group consisting of halides, preferably fluorides, chlorides, bromides, and iodides, more particularly fluorides and chlorides, alkoxy groups, preferably alkoxy groups O—R^{a}, in which R^{a} is an optionally C₁₋₆-alkoxy-substituted C₁₋₁₆ aliphatic radical, preferably C₁₋₁₀ aliphatic radical, more preferably C₁₋₆ aliphatic radical, more particularly C₁₋₆ alkyl radical, such as methyl, ethyl, n-propyl, isopropyl, n-butyl, isobutyl, or tert-butyl, or carboxylate groups, preferably C₁₋₆ carboxylate groups, more particularly carboxylate groups selected from the group consisting of acetate, and very preferably diketonate groups selected from the group consisting of acetylacetonate, acetonylacetonate, and diacetylate.

A “hydrolyzable group”, such as, for example, of the groups X¹ and X², refers more preferably to an alkoxy group, preferably an alkoxy group O—R^{a}, in which R^{a} is an optionally C₁₋₆-alkoxy-substituted C₁₋₁₆ aliphatic radical, preferably C₁₋₁₀ aliphatic radical, more preferably C₁₋₆ aliphatic radical, more particularly C₁₋₆ alkyl radical, such as methyl, ethyl, n-propyl, isopropyl, n-butyl, isobutyl, or tert-butyl.

The skilled person is familiar with the term “valence” in connection with metal atoms or semimetal atoms such as M¹ and M². In the sense of the present invention, the valence preferably denotes the oxidation number of the respective metal atom or semimetal atom such as M¹ and M², for example. Valences for x and y—in each case independently of one another—are preferably +2, +3, and +4, more particularly +3 and +4.

Suitable metal atoms such as M¹ and M², for example, are all customary metal atoms, including transition metal atoms, which may be a constituent of the at least one starting compound, more particularly (A1) and/or (A2), such as Al, Ti, Zr, and Fe, for example, preferably Ti and Zr. Suitable semimetal atoms such as M¹ and M², for example, are all customary semimetal atoms which may be a constituent of the at least one starting compound, more particularly (A1) and/or (A2), such as B and Si, for example, preferably Si.

The metal atoms and semimetal atoms, such as M¹ and M², for example, are preferably selected in each case independently of one another from the group consisting of Al, Ti, Zr, Fe, B, and Si, more preferably from the group consisting of Ti, Zr, and Si, very preferably from the group consisting of Zr and Si. In particular the metal atoms and semimetal atoms such as M¹ and M², for example, each are Si.

M¹ more particularly is selected from the group consisting of Al, Ti, Zr, Fe, B, and Si, more preferably from the group consisting of Ti, Zr, and Si, very preferably from the group consisting of Zr and Si, and more particularly M¹ is Si. Preferably M² is Si.

The valences x, y, and z of the metal atoms and semimetal atoms such as M¹ and M², for example, are preferably selected such that the metal atoms and semimetal atoms such as M¹ and M², for example, are selected in each case independently of one another from the group consisting of Al³⁺, Ti⁴⁺, Zr⁴⁺, Fe³⁺, Fe⁴⁺, B³⁺, and Si⁴⁺, more preferably from the group consisting of Al³⁺, Ti⁴⁺, Zr⁴⁺, and Si⁴⁺, very preferably from the group consisting of Ti⁴⁺, Zr⁴⁺, and Si⁴⁺, and more particularly are each Si⁴⁺.

The skilled person is aware of the term “nonhydrolyzable organic radical”. Any customary organic radical which is known to the skilled person and is nonhydrolyzable may serve as a constituent of the at least one starting compound used in preparing the aqueous sol-gel composition (II), more particularly of the at least one component (A1) and/or (A2).

A “nonhydrolyzable organic radical”, in connection for example with the radicals R¹, R², and R³, in each case independently of one another, refers preferably to a nonhydrolyzable organic radical selected from the group consisting of C₁₋₁₀ aliphatic radicals, C₁₋₁₀ heteroaliphatic radicals, C₃₋₁₀ cycloaliphatic radicals, 3-10-membered heterocycloaliphatic radicals, 5-12-membered aryl or heteroaryl radicals, C₃₋₁₀ cycloaliphatic radicals bonded via a C₁₋₆ aliphatic radical, 3-10-membered heterocycloaliphatic radicals bonded via a C₁₋₆ aliphatic radical, 5-12-membered aryl or heteroaryl radicals bonded via a C₁₋₆ aliphatic radical, it being possible for each of these radicals optionally to comprise at least one reactive functional group, provided the bond of the nonhydrolyzable organic radical to the metal atom or semimetal atom such as M¹ and/or M², for example, especially if M¹ and/or M² are each Si, cannot be cleaved hydrolytically under customary reaction conditions known to the skilled person.

The expression “C₁₋₁₀ aliphatic radical” in the sense of this invention encompasses preferably acyclic saturated or unsaturated, preferably saturated, aliphatic hydrocarbon radicals, i.e., C₁₋₁₀ aliphatic radicals which may in each case be branched or unbranched and also unsubstituted or mono- or polysubstituted, having 1 to 10 carbon atoms, i.e., C₁₋₁₀ alkanyls, C₂₋₁₀ alkenyls, and C₂₋₁₀ alkynyls. Alkenyls have at least one C—C double bond, and alkynyls have at least one C—C triple bond. Preference is given to a C₁₋₁₀ aliphatic radical selected from the group which encompasses methyl, ethyl, n-propyl, 2-propyl, n-butyl, isobutyl, sec-butyl, tert-butyl, n-pentyl, isopentyl, neopentyl, n-hexyl, n-heptyl, n-octyl, n-nonyl, and n-decyl.

The expression “C₁₋₁₀ heteroaliphatic radical” in the sense of this invention encompasses preferably C₁₋₁₀ aliphatic radicals in which at least one, alternatively optionally 2 or 3, carbon atom or atoms has or have been replaced by a heteroatom such as N, O, or S or by a heteroatom group such as NH, N(C₁₋₁₀ aliphatic radical), or N(C₁₋₁₀ aliphatic radical)₂.

The expression “C₃₋₁₀ cycloaliphatic radical” in the sense of this invention encompasses preferably cyclic aliphatic (cycloaliphatic) hydrocarbons having 3, 4, 5, 6, 7, 8, 9, or 10 carbon atoms, it being possible for the hydrocarbons to be saturated or unsaturated (but not aromatically), unsubstituted or mono- or polysubstituted. The bonding of the C₃₋₁₀ cycloaliphatic radical to the respective superordinate general structure may take place by any desired and possible ring member of the C₃₋₁₀ cycloaliphatic radical, but is preferably via a carbon atom. The C₃₋₁₀ cycloaliphatic radicals may also be singly or multiply bridged, such as, for example, in the case of adamantyl, bicyclo[2.2.1]heptyl, or bicyclo[2.2.2]octyl. Preference is given to a C₃₋₁₀ cycloaliphatic radical selected from the group which encompasses cyclopropyl, cyclobutyl, cyclopentyl, cyclohexyl, and cycloheptyl.

The expression “3-10-membered heterocycloaliphatic radical” encompasses preferably aliphatic saturated or unsaturated (but not aromatic) cycloaliphatic radicals having three to ten, i.e., 3, 4, 5, 6, 7, 8, 9, or 10, ring members, in which at least one, optionally alternatively 2 or 3, carbon atom or atoms has or have been replaced by a heteroatom such as N, O, or S, or by a heteroatom group such as NH, N(C₁₋₁₀-aliphatic radical) or N(C₁₋₁₀-aliphatic radical)₂, it being possible for the ring members to be unsubstituted or mono- or polysubstituted. The bonding to the superordinate general structure may be via any desired and possible ring member of the heterocycloaliphatic radical, but is preferably via a carbon atom. Preference is given to 3-10-membered heterocycloaliphatic radicals from the group encompassing azetidinyl, aziridinyl, azepanyl, azocanyl, diazepanyl, dithiolanyl, dihydroquinolyl, dihydropyrrolyl, dioxanyl, dioxolanyl, dioxepanyl, dihydroindenyl, dihydropyridyl, dihydrofuranyl, dihydroisoquinolyl, dihydroindolinyl, dihydroisoindolyl, imidazolidinyl, isoxazolidinyl, morpholinyl, oxiranyl, oxetanyl, pyrrolidinyl, piperazinyl, 4-methylpiperazinyl, piperidyl, pyrazolidinyl, pyranyl, tetrahydropyrrolyl, tetrahydropyranyl, tetrahydroquinolyl, tetrahydro-isoquinolyl, tetrahydroindolinyl, tetrahydrofuranyl, tetrahydropyridyl, tetrahydrothiophenyl, tetrahydro-pyridoindolyl, tetrahydronaphthyl, tetrahydro-carbolinyl, tetrahydroisoxazolopyridyl, thiazolidinyl, and thiomorpholinyl.

The term “aryl” in the sense of this invention denotes aromatic hydrocarbons having 6 to 12 ring members, preferably 6 ring members, including phenyls and naphthyls. Each aryl radical may be unsubstituted or singly or multiply substituted, it being possible for the aryl substituents to be identical or different and to be in any desired and possible position of the aryl. The bonding of the aryl to the superordinate general structure may be via any desired and possible ring member of the aryl radical. Aryl is selected preferably from the group containing phenyl, 1-naphthyl, and 2-naphthyl.

The term “heteroaryl” stands for a 5- to 12-membered, preferably 5- or 6-membered cyclic aromatic radical which contains at least 1, optionally also 2, 3, 4 or 5 heteroatoms, the heteroatoms being selected each independently of one another from the group S, N, and O, and it being possible for the heteroaryl radical to be unsubstituted or mono- or polysubstituted; in the case of substitution on the heteroaryl, the substituents may be identical or different and may be in any desired and possible position of the heteroaryl. Bonding to the superordinate general structure may be via any desired and possible ring member of the heteroaryl radical. It is preferred for the heteroaryl radical to be selected from the group which encompasses benzofuranyl, benzimidazolyl, benzothienyl, benzothiadiazolyl, benzothiazolyl, benzotriazolyl, benzoxazolyl, benzoxadiazolyl, quinazolinyl, quinoxalinyl, carbazolyl, quinolyl, dibenzofuranyl, dibenzothienyl, furyl (furanyl), imidazolyl, imidazothiazolyl, indazolyl, indolizinyl, indolyl, isoquinolyl, isoxazolyl, isothiazolyl, indolyl, naphthyridinyl, oxazolyl, oxadiazolyl, phenazinyl, phenothiazinyl, phthalazinyl, pyrazolyl, pyridyl (2-pyridyl, 3-pyridyl, 4-pyridyl), pyrrolyl, pyridazinyl, pyrimidinyl, pyrazinyl, purinyl, phenazinyl, thienyl (thiophenyl), triazolyl, tetrazolyl, thiazolyl, thiadiazolyl, or triazinyl.

The expression “C₃-C₁₀ cycloaliphatic radical, 3-10-membered heterocycloaliphatic radical, 5-12-membered aryl or heteroaryl radical bonded via a C₁₋₆ aliphatic radical” means preferably that the stated radicals have the definitions defined above and are each bonded via a C₁₋₆ aliphatic radical to the respective superordinate general structure, it being possible for said aliphatic radical to be branched or unbranched, saturated or unsaturated, and unsubstituted or monosubstituted or polysubstituted.

If a radical or a group such as, for example, the group X¹ within the compound (A1), or a nonhydrolyzable organic radical such as the radicals R² and R³ within the compound (A2), occurs multiply within one molecule, then this radical or this group may in each case have identical or different definitions: if, for example, the group X¹ is O—R^{a}, where R^{a} is a C₁₋₆ aliphatic radical, and if, for example, it occurs a total of three times within the molecule (M¹)^{x}(X¹)ₐ(R¹), then X may, for example, be O—C₂H₅ each of the three times, or may be once O—C₂H₅, once O—CH₃, and once O—C₃H₆. If R² and R³ within (A2) are each a nonhydrolyzable organic radical, then one of these radicals, for example, may have at least one reactive functional group, and the remaining radical may have no reactive functional group.

The radicals T, U, V, and W are, in each case independently of one another, a radical which has 1 to 30 carbon atoms and may optionally have up to 10 heteroatoms and heteroatom groups selected from the group consisting of O, S, and N. The radicals T, U, V, and W may be aliphatic, heteroaliphatic, cycloaliphatic, heterocycloaliphatic, aromatic, or heteroaromatic, and partially (hetero)aromatic radicals as well are possible, i.e., (hetero)aromatic radicals which are substituted by at least one aliphatic, heteroaliphatic, cycloaliphatic and/or heterocycloaliphatic group. To the skilled person it is clear that the radicals T, U, V, and W are divalent or trivalent and function as bridging organic groups between two or three metal and/or semimetal atoms. If, for example, R¹ is (U)[(M¹)^{x}(X¹)_{c}]₂, then U is a trivalent group which bridges a radical (M¹)^{x}(X¹)ₐ with two radicals [(M¹)^{x}(X¹)_{c}].

Within the compound (M¹)^{x}(X¹)ₐ(R¹) used as component (A1), all of the groups X¹ preferably have the same definition; more preferably, all of the groups X¹ within the compound (M¹)^{x}(X¹)ₐ(R¹) used as component (A1) stand for O—R^{a}, where R^{a} is preferably a C₁₋₆ aliphatic radical, more particularly a C₁₋₆ alkyl radical, most preferably wherein R^{a} is methyl, ethyl, n-propyl, isopropyl, n-butyl, isobutyl, or tert-butyl.

Within the compound used as component (A2), all of the groups X² preferably have the same definition; more preferably, all of the groups X² within the compound used as component (A2) stand for O—R^{a}, where R^{a} is a C₁₋₆ aliphatic radical, more particularly a C₁₋₆ alkyl radical, most preferably wherein R³ is methyl, ethyl, n-propyl, isopropyl, n-butyl, isobutyl, or tert-butyl.

With preference
M¹ and M² are selected each independently from one another from the group consisting of Al, Ti, Zr, Fe, B, and Si, more preferably from the group consisting of Al, Ti, Zr, and Si, very preferably from the group consisting of Ti, Zr, and Si, especially preferably from the group consisting of Zr and Si, and most preferably M¹ and M² are each Si,
or M¹ is selected from the group consisting of Al, Ti, Zr, Fe, B, and Si, more preferably from the group consisting of Al, Ti, Zr, and Si, very preferably from the group consisting of Ti, Zr, and Si, especially preferably from the group consisting of Zr and Si, most preferably Si, and M² is Si,
X¹ and X² each independently of one another are an alkoxy group O—R^{a}, where R^{a} is in each case a C₁₋₆ aliphatic radical, preferably a C₁₋₆ alkyl radical, more preferably in which R³ is methyl, ethyl, n-propyl, isopropyl, n-butyl, isobutyl, or tert-butyl.

The aqueous sol-gel composition (II) used in step (2) of the process of the invention is preferably obtainable by reaction of

at least one compound (A1) as at least one starting compound, in which R¹ is a nonhydrolyzable organic radical which has at least one reactive functional group selected from the group consisting of primary amino groups, secondary amino groups, epoxide groups, thiol groups, isocyanate groups, phosphorus-containing groups, and groups which have an ethylenically unsaturated double bond,
in particular at least one compound (A1) as at least one starting compound, in which R¹ is a nonhydrolyzable organic radical which has at least one epoxide group as a reactive functional group, and optionally further
at least one further compound (A1) as at least one starting compound, in which R¹ is a nonhydrolyzable organic radical which has at least one reactive functional group selected from the group consisting of primary amino groups and secondary amino groups,
   and optionally at least one further compound (A1), in which R¹ is X¹,
   and optionally at least one further compound (A1), in which R¹ is a nonhydrolyzable organic radical which has no reactive functional group,
   and optionally at least one compound (A2).

The aqueous sol-gel composition (II) used in step (2) is preferably obtainable by reaction of
at least one compound Si(X¹)₃(R¹) as at least one compound (A1-1),
   where R¹ therein is a nonhydrolyzable organic radical which has at least one reactive functional group selected from the group consisting of primary amino groups, secondary amino groups, epoxide groups, and groups which have an ethylenically unsaturated double bond,
      in particular at least one compound Si(X¹)₃(R¹) as at least one compound (A1-1a),
      where R¹ therein is a nonhydrolyzable organic radical which has at least one epoxide group as a reactive functional group, and further optionally
      at least one further compound Si(X¹)₃(R¹) as at least one further compound (A1-1b),
      where R¹ therein is a nonhydrolyzable organic radical which has at least one reactive functional group selected from the group consisting of primary amino groups and secondary amino groups,
         and optionally at least one compound Si(X¹)₄ as at least one further compound (A1-2),
and optionally at least one compound Si(X¹)₃(R¹) as at least one further compound (A1-3),
   where R¹ therein is a nonhydrolyzable organic radical which has no reactive functional group,
and optionally at least one compound Zr(X¹)₄ as at least one further compound (A1-4),
   with water.

In one particularly preferred embodiment the aqueous sol-gel composition (II) used in step (2) of the process of the invention is obtainable by reaction of
at least one compound Si(X¹)₃(R¹) as at least one compound (A1-1),
   where R¹ therein is a nonhydrolyzable organic radical which has at least one reactive functional group selected from the group consisting of primary amino groups, secondary amino groups, epoxide groups, and groups which have an ethylenically unsaturated double bond, more particularly at least one epoxide group,
   and where the nonhydrolyzable organic radical is preferably selected from the group consisting of C₁-C₁₀ aliphatic radicals and C₁-C₁₀ heteroaliphatic radicals, more preferably selected from C₁₋₁₀ aliphatic radicals,
   X¹ is OR^{a} and R^{a} is a C₁₋₆-alkyl radical,
      optionally at least one further compound Si(X¹)₃(R¹) as at least one further compound (A1-1),
where R¹ therein is a nonhydrolyzable organic radical which has at least one reactive functional group selected from the group consisting of primary amino groups, secondary amino groups, epoxide groups, and groups which have an ethylenically unsaturated double bond, more particularly at least one primary amino group or one secondary amino group,
and where the nonhydrolyzable organic radical is preferably selected from the group consisting of C₁₋₁₀ aliphatic radicals and C₁₋₁₀ heteroaliphatic radicals, more preferably selected from C₁₋₁₀ aliphatic radicals,
X¹ is OR^{a} and R^{a} is a C₁₋₆ alkyl radical,
and optionally at least one compound Si(X¹)₄ as at least one further compound (A1-2), in which X¹ is OR^{a} and R^{a} is a C₁₋₆ alkyl radical,
and optionally at least one compound Si(X¹)₃(R¹) as at least one further compound (A1-3),
where R¹ therein is a nonhydrolyzable organic radical which has no reactive functional group,
and where the nonhydrolyzable organic radical is preferably selected from the group consisting of C₁-C₁₀ aliphatic radicals, C₁-C₁₀ heteroaliphatic radicals, 5-12-membered aryl or heteroaryl radicals, and 5-12-membered aryl or heteroaryl radicals bonded via a C₁₋₆ aliphatic radical,
   and X¹ is OR^{a} and R^{a} is a C₁₋₆-alkyl radical,
and optionally at least one compound Z^{r}(X¹)₄ as at least one further compound (A1-4), in which X is OR^{a} and R^{a} is a C₁₋₆ alkyl radical,
   with water.

With particular preference the aqueous sol-gel composition (II) is obtainable in step (2) by reaction of
at least one compound Si(X¹)₃(R¹) as at least one compound (A1-1a),
   where R¹ therein is a nonhydrolyzable C₁-C₁₀ aliphatic organic radical which has at least one epoxide group as reactive functional group,
   X¹ is OR^{a} and R^{a} is a C₁₋₆ alkyl radical,
optionally at least one further compound Si(X¹)₃(R¹) as at least one further compound (A1-1b),
   where R¹ therein is a nonhydrolyzable C₁₋₁₀ aliphatic organic radical which has at least one primary amino group as reactive functional group,
   X¹ is OR^{a} and R^{a} is a C₁₋₆ alkyl radical,
and optionally at least one compound Si(X¹)₄ as at least one further compound (A1-2),
   in which X¹ is OR^{a} and R^{a} is a C₁₋₆ alkyl radical,
and optionally at least one compound Si(X¹)₃(R¹) as at least one further compound (A1-3),
   where R¹ therein is a nonhydrolyzable organic C₁-C₁₀ aliphatic radical which has no reactive functional group,
   and in which the nonhydrolyzable organic radical R¹ is preferably selected from the group consisting of C₁-C₁₀ aliphatic radicals, 5-12-membered aryl or heteroaryl radicals, and 5-12-membered aryl or heteroaryl radicals bonded via a C₁₋₆ aliphatic radical,
and X¹ is OR^{a} and R^{a} is a C₁₋₆ alkyl radical,
   and optionally at least one compound Zr(X¹)₄ as at least one further compound (A1-4), in which X¹ is OR^{a} and R^{a} is a C₁₋₆ alkyl radical,
   with water.

With more particular preference the aqueous sol-gel composition (II) is obtainable by reaction of
at least one compound Si(X¹)₃(R¹) as at least one compound (A1-1a),
   where R¹ therein is a nonhydrolyzable C₁-C₁₀ aliphatic organic radical which has at least one epoxide group as reactive functional group,
   X¹ is OR^{a} and R^{a} is a C₁₋₆ alkyl radical,
optionally at least one further compound Si(X¹)₃(R¹) as at least one further compound (A1-1b),
   where R¹ therein is a nonhydrolyzable C₁₋₁₀ aliphatic organic radical which has at least one primary amino group as reactive functional group,
   X¹ is OR^{a} and R^{a} is a C₁₋₆ alkyl radical,
and at least one compound Si(X¹)₄ as at least one compound (A1-2),
   in which X¹ is OR^{a} and R^{a} is a C₁₋₆ alkyl radical,
and at least one compound Si(X¹)₃(R¹) as at least one further compound (A1-3),
   where R¹ therein is a nonhydrolyzable organic C₁-C₁₀ aliphatic radical which has no reactive functional group,
   and in which the nonhydrolyzable organic radical R¹ is preferably selected from the group consisting of C₁-C₁₀ aliphatic radicals, 5-12-membered aryl or heteroaryl radicals, and 5-12-membered aryl or heteroaryl radicals bonded via a C₁₋₆ aliphatic radical, and is more preferably selected from C₁₋₁₀ aliphatic radicals,
and X¹ is OR^{a} and R^{a} is a C₁₋₆ alkyl radical,
   and optionally at least one compound Zr(X¹)₄ as at least one further compound (A1-4), in which X¹ is OR^{a} and R^{a} is a C₁₋₆ alkyl radical,
   with water.

Where the aqueous sol-gel composition (II) used in accordance with the invention is prepared using at least two starting compounds, such as, for example, two compounds (A1) different from one another, such as (A1-1a) and (A1-1b), the relative weight ratio of these two components to one another, such as (A1-1a) and (A1-1b), for example, is preferably in a range from 10:1 to 1:10, more preferably in a range from 7.5:1 to 1:7.5, very preferably in a range from 5:1 to 1:5, more particularly in a range from 2:1 to 1:2.

Where the aqueous sol-gel composition used in accordance with the invention is prepared using at least three starting compounds, such as, for example, three compounds (A1) different from one another, as for example the compounds designated above as (A1-1), (A1-2) and (A1-3) or for example three compounds (A1) different from one another such as (A1-1a), (A1-1b) and (A1-2), the relative weight ratio of the components (A1-1), (A1-2) and (A1-3) or of the components (A1-1a), (A1-1b) and (A1-2) to one another is preferably in a range from 5:1:1 to 1:1:5 or in a range from 5:1:1 to 1:5:1 or in a range from 1:5:1 to 5:1:1 or in a range from 1:5:1 to 1:1:5 or in a range from 1:1:5 to 5:1:1 or in a range from 1:1:5 to 1:5:1, more preferably in a range from 2:1:1 to 1:1:2 or in a range from 2:1:1 to 1:2:1 or in a range from 1:2:1 to 2:1:1 or in a range from 1:2:1 to 1:1:2 or in a range from 1:1:2 to 2:1:1 or in a range from 1:1:2 to 1:2:1.

Where the aqueous sol-gel composition used in accordance with the invention is prepared using at least four starting compounds, such as, for example, four compounds (A1) different from one another, as for example the compounds designated above as (A1-1), (A1-2), (A1-3) and (A1-4) or for example the compounds designated above as (A1-1a), (A1-1b), (A1-2) and (A1-3), the relative weight ratio of the components (A1-1), (A1-2) and (A1-3), and also (A1-4) and (A1-1a), (A1-1b), (A1-2) and (A1-3) to one another is situated preferably in a range from 5:1:1:1 to 1:1:1:5 or from 5:1:1:1 to 1:1:5:1 or from 5:1:1:1 to 1:5:1:1 or from 1:5:1:1 to 5:1:1:1 or from 1:5:1:1 to 1:1:5:1 or from 1:5:1:1 to 1:1:1:5 or from 1:1:5:1 to 5:1:1:1 or from 1:1:5:1 to 1:5:1:1 or from 1:1:5:1 to 1:1:1:5 or from 1:1:1:5 to 5:1:1:1 or from 1:1:1:5 to 1:5:1:1 or from 1:1:1:5 to 1:1:5:1, more preferably in a range from 2:1:1:1 to 1:1:1:2 or from 2:1:1:1 to 1:1:2:1 or from 2:1:1:1 to 1:2:1:1 or from 1:2:1:1 to 2:1:1:1 or from 1:2:1:1 to 1:1:2:1 or from 1:2:1:1 to 1:1:1:2 or from 1:1:2:1 to 2:1:1:1 or from 1:1:2:1 to 1:2:1:1 or from 1:1:2:1 to 1:1:1:2 or from 1:1:1:2 to 2:1:1:1 or from 1:1:1:2 to 1:2:1:1 or from 1:1:1:2 to 1:1:5:1.

In one especially preferred embodiment the relative weight ratio of components (A1-1a), (A1-1b), (A1-2) and (A1-3) to one another is in a range from 2.2:0.5:1.2:1.2 to 2:0.5:1:1.

Suitability for preparing the aqueous sol-gel composition (II) used in step (2) of the present invention is possessed by, for example, at least one compound (M¹)^{x}(X¹)ₐ(R¹) as component (A1), in which R¹ has the definition X¹. Examples of such compounds are tetramethoxysilane (TMOS), tetraethoxysilane (TEOS), dimethoxydiethoxysilane, tetrapropoxysilane, tetra-isopropoxysilane, tetrabutoxysilane, titanium tetraiso-propoxide, titanium tetrabutoxide, zirconium tetraiso-propoxide, and zirconium tetrabutoxide.

Suitability for preparing the aqueous sol-gel composition used in step (2) of the process of the invention is possessed by, for example, at least one compound (M¹)^{x}(X¹)ₐ(R¹) as component (A1), in which R¹ is a nonhydrolyzable organic radical, it being possible for the nonhydrolyzable organic radical R¹ to have optionally at least one reactive functional group.

If the nonhydrolyzable organic radical R¹ here has at least one group which comprises a vinyl group as ethylenically unsaturated double bond, then suitability as component (A1) is possessed by, for example, vinyltrimethoxysilane (VTMS), vinyltriethoxysilane, vinyltriisopropoxysilane, vinyltrichlorosilane, vinyl-tris(2-methoxyethoxy)silane, vinyltriacetoxysilane, p-styryltrimethoxysilane, and/or p-styryltriethoxysilane.

If the nonhydrolyzable organic radical R¹ here has at least one group which comprises a (meth)acrylic group as ethylenically unsaturated double bond, then suitability as component (A1) is possessed by, for example, γ-(meth)-acryloyloxypropyltrimethoxysilane (MAPTS), γ-(meth)-acryloyloxypropyltriethoxysilane, γ-(meth)acryloyloxy-propyltriisopropoxysilane, β-(meth)acryloyloxyethyl-trimethoxysilane, β-(meth)acryloyloxyethyltriethoxy-silane, β-(meth)acryloyloxyethyltriisopropoxysilane, 3-(meth)acryloyloxypropyltriacetoxysilane, (meth)acrylamido-propyltriethoxysilane, (meth)acrylamidopropyltrimethoxy-silane, (meth)acrylamidopropyldimethoxyethoxysilane and/or (meth)acrylamidopropylmethoxydiethoxysilane.

If the nonhydrolyzable organic radical R¹ here has at least one group which comprises an isocyanate group, then suitability as component (A1) is possessed by, for example, γ-isocyanatopropyltriethoxysilane and/or γ-isocyanatopropyltrimethoxysilane.

If the nonhydrolyzable organic radical R¹ here has at least one group which comprises at least one primary and/or secondary amino group, then suitability as component (A1) is possessed by, for example, 3-aminopropyltrimethoxysilane (APS), 3-aminopropyltriethoxysilane, 3-aminopropyltriisopropoxysilane, 2-aminoethyltrimethoxysilane, 2-aminoethyltriethoxysilane, 2-aminoethyltriisopropoxysilane, aminomethyltrimethoxy-silane, aminomethyltriethoxysilane, aminomethyltri-isopropoxysilane, 3-(2-aminoethyl)aminopropyltrimethoxysilane (AEAPS), 3-(2-aminoethyl)aminopropyltriethoxysilane, 3-(2-aminoethyl)aminopropyltriisopropoxysilane, 2-(2-aminoethyl)aminoethyltrimethoxysilane, 2-(2-amino-ethyl)aminoethyltriethoxysilane, 2-(2-aminoethyl)aminoethyltriisopropoxysilane, 3-(3-aminopropyl)aminopropyltrimethoxysilane, 3-(3-aminopropyl)aminopropyltriethoxysilane, 3-(3-aminopropyl)aminopropyltriisopropoxysilane, diethylenetriaminopropyltrimethoxysilane, diethylene-triaminopropyltriethoxysilane, N-(n-butyl)-3-aminopropyltrimethoxysilane, N-(n-butyl)-3-aminopropyltriethoxysilane, N-cyclohexylaminomethyltriethoxysilane, N-cyclo-hexylaminomethyltrimethoxysilane, N-ethyl-γ-aminoisobutyl-trimethoxysilane, N-ethyl-γ-aminoisobutyltriethoxysilane, N-(vinylbenzyl)-2-aminoethyl-3-aminopropyltrimethoxysilane hydrochloride, N-phenyl-γ-aminopropyltrimethoxysilane, N-phenyl-γ-aminopropyltriethoxysilane, γ-ureidopropyl-trimethoxysilane, γ-ureidopropyltriethoxysilane, N-methyl-[3-(trimethoxysilyl)propyl]carbamate, and/or N-trimethoxy-silylmethyl-O-methylcarbamate.

If the nonhydrolyzable organic radical R¹ here has at least one group which comprises at least one epoxide group, then suitability as component (A1) is possessed by, for example, 3-glycidyloxypropyltrimethoxysilane (GPTMS), 3-glycidyloxypropyltriethoxysilane, 3-glycidyloxypropyl-triisopropoxysilane, 2-glycidyloxyethyltrimethoxysilane, 2-glycidyloxyethyltriethoxysilane, 2-glycidyloxyethyl-triisopropoxyoxysilane, β-(3,4-epoxycyclohexyl)ethyltrimethoxysilane, and/or β-(3,4-epoxycyclohexyl)ethyltriethoxysilane.

If the nonhydrolyzable organic radical R¹ here has at least one group which comprises at least one thiol group, then suitability as component (A1) is possessed by, for example, 3-mercaptopropyltrimethoxysilane (MPTMS), 3-mercaptopropyltriethoxysilane, 3-mercapto-propyltriisopropoxysilane, 2-mercaptoethyltrimethoxy-silane, 2-mercaptoethyltriethoxysilane and/or 2-mercapto-ethyltriisopropoxysilane.

If the nonhydrolyzable organic radical R¹ here has at least one group which is phosphorus-containing, then suitability as component (A1) is possessed by, for example, dimethylphosphonatoethyltrimethoxysilane, dimethylphosphonatoethyltriethoxysilane (PHS), dimethyl-phosphonatoethyltriisopropoxysilane, diethylphosphonato-ethyltrimethoxysilane, diethylphosphonatoethyltriethoxy-silane (PHS) and/or diethylphosphonatoethyltriiso-propoxysilane.

Suitability for preparing the aqueous sol-gel composition used in step (2) of the process of the invention is possessed, moreover, by at least one compound (M¹)^{x}(X¹)ₐ(R¹) as component (A1), in which R¹ is a nonhydrolyzable organic radical, it being possible for the nonhydrolyzable organic radical R¹ to have no reactive functional group.

If the nonhydrolyzable organic radical R¹ here has no reactive functional group, then suitability as component (A1) is possessed by, for example, methyltrimethoxysilane (MTMS), methyltriethoxysilane (MTES), methyltripropoxy-silane, methyltriisopropoxysilane, ethyltrimethoxysilane, ethyltriethoxysilane, ethyltripropoxysilane, ethyltri-isopropoxysilane, octyltrimethoxysilane, isobutyltri-ethoxysilane, isobutyltrimethoxysilane, octyltriethoxy-silane, hexyltrimethoxysilane, hexyltriethoxysilane, decyltrimethoxysilane, decyltriethoxysilane, hexadecyl-trimethoxysilane, hexadecyltriethoxysilane, isooctyl-trimethoxysilane, isooctyltriethoxysilane, phenyltri-methoxysilane (PHS), phenyltriethoxysilane, phenyl-tripropoxysilane, phenyltriisopropoxysilane, benzyltrimethoxy-silane, benzyltriethoxysilane, benzyltripropoxysilane, benzyltriisopropoxysilane, octyltrichlorosilane, tridecafluorooctyltriethoxysilane, tridecafluorooctyltri-methoxysilane, 3-octanoylthio-1-propyltriethoxysilane, 3-octanoylthio-1-propyltrimethoxysilane, 3-triethoxysilyl-N-(1,3-dimethylbutylidenepropylamine, 3-chloropropyltrimethoxysilane and/or 3-chloropropyltriethoxysilane.

Suitability for preparing the aqueous sol-gel composition used in step (2) of the process of the invention is possessed by, for example, at least one compound (M¹)^{x}(X¹)ₐ(R¹) as component (A1), in which R¹ is (T)(M¹)^{x}(X¹)_{c}. Examples of those suitable here include bis(trimethoxysilyl)ethane, bis(triethoxysilyl)ethane, bis-[γ-(triethoxysilyl) propyl]amine, bis-[γ-(trimethoxy-silyl)propyl]amine, bis(triethoxysilylpropyl) tetrasulfide and/or bis(trimethoxysilylpropyl) tetrasulfide.

Suitability for preparing the aqueous sol-gel composition used in step (2) of the process of the invention is possessed by, for example, at least one compound (M¹)^{x}(X¹)ₐ(R¹) as component (A1), in which R¹ is (U)[(M¹)^{x}(X¹)_{c}]₂. Examples of those suitable here include tris[3-(trimethoxysilyl)propyl]isocyanurate.

Suitability for preparing the aqueous sol-gel composition used in step (2) of the process of the invention is possessed by, for example, at least one compound (M²)^{y}(X²)_{b}(R²)(R³) as component (A2), in which R² and R³ independently of one another are each a nonhydrolyzable organic radical. Examples of those suitable here include 3-glycidyloxypropylmethyldiethoxysilane, 3-glycidyloxy-propylmethyldimethoxysilane, γ-(meth)acryloyloxypropyl-methyldimethoxysilane, 3-mercaptopropylmethyldimethoxy-silane, 3-mercaptopropylmethyldiethoxysilane, γ-(meth)-acryloxypropylmethyldiethoxysilane, N-(2-aminoethyl)-3-aminopropylmethyldimethoxysilane, N-(2-aminoethyl)-3-aminopropylmethyldiethoxysilane, 3-aminopropylmethyldiethoxysilane, 3-aminopropylmethyldimethoxysilane, dimethyldimethoxysilane, dimethyldiethoxysilane, di-tert-butoxydiacetoxysilane, vinyldimethoxymethylsilane, vinyldiethoxymethylsilane, N-cyclohexylamino-methylmethyl-diethoxysilane, N-cyclohexylaminomethylmethyldimethoxy-silane, (cyclohexyl)methyldimethoxysilane, dicyclopentyl-dimethoxysilane and/or N-dimethoxy(methyl)silylmethyl-O-methylcarbamate.

In one preferred embodiment of the process according to the invention the solids content of the aqueous sol-gel composition (II) used in step (2) after hydrolysis and condensation of the at least one starting compound is in a range from 0.01 up to 10 wt %, more preferably in a range from 0.05 up to 7.5 wt %, very preferably in a range from 0.1 up to 5 wt %, more particularly in a range from 0.2 up to 2 wt %, or in a range from 0.2 up to 1 wt %, based in each case on the total weight of the aqueous composition.

The solids content of the aqueous sol-gel composition (II) used in accordance with the invention may be determined by means of calculation from the amount of the at least one starting compound used in preparing the sol-gel composition. This procedure is employed especially when the target solids content is specified beforehand and is to be adjusted accordingly. Hydrolysis of the hydrolyzable groups present in the at least one starting compound, such as of the hydrolyzable groups X¹, for example, and, furthermore, condensation of all of the metal-OH and/or semimetal-OH bonds formed by such hydrolysis, such as M¹-OH bonds, for example, is assumed in that case. For the calculation of the solids content of the aqueous sol-gel composition used in accordance with the invention, all of any single bonds present that are formed between a nonhydrolyzable group, such as a nonhydrolyzable organic radical such as R¹, and a metal atom or semimetal atom, such as M¹, are considered to form part of the solids content and are counted accordingly. The solids content of the aqueous sol-gel composition used in accordance with the invention is preferably determined by means of this calculation method. The theoretically calculated solids content may be calculated for each of the at least one starting compound used in preparing the aqueous sol-gel composition employed in accordance with the invention, in accordance with the general formula

$${SC}_{theo} = \frac{{M}_{cond}}{{M}_{start}} \cdot {fraction}_{formula}$$

in which
SCₜₕₑₒ=theoretically calculated solids content in wt %,
M_{cond}=molar mass of the condensed starting compound, in g/mol,
Mₛₜₐᵣₜ=molar mass of the starting compound, in g/mol, and
fraction_{formula}=fraction of the starting compound in the composition, in wt %.

An example calculation for determining the theoretically calculated solids content of an aqueous sol-gel composition employed in accordance with the invention is given in section 1 of the experimental part (inventive and comparative examples).

The solids content calculated theoretically in this way is in agreement with the values in the experimental method of determination described below for determining the solids content of the aqueous sol-gel composition when the aqueous sol-gel composition contains no further nonvolatile constituents other than the at least one starting compound used in preparing the aqueous sol-gel composition—such as additives, for example. In the case of this experimental solids content determination method, which can be used universally for the purposes of the present invention, the inventively employed aqueous sol-gel composition is weighed in an amount of 2±0.2 g and dried for a period of 60 minutes at a temperature of 130° C. in accordance with DIN EN ISO 3251 (date: Jun. 1, 2008).

The aqueous sol-gel composition (II) may optionally comprise at least one additive, preferably selected from the group consisting of hydrolytically and pyrolytically prepared silica, organic and inorganic nanoparticles, each preferably having a mean particle size in the range from 1 to 150 nm as determinable by dynamic light scattering in accordance with DIN ISO 13321 (date: Oct. 1, 2004), water-soluble or water-dispersible organic polymers, surface-active compounds such as surfactants, emulsifiers, antioxidants, wetting agents, dispersants, flow control assistants, solubilizers, defoamers, stabilizers, preferably heat stabilizers, processing stabilizers, and UV and/or light stabilizers, catalysts, waxes, flexibilizers, flame retardants, reactive diluents, carrier media, resins, adhesion promoters, processing assistants, plasticizers, solids in powder form, solids in fiber form, preferably solids in powder or fiber form selected from the group consisting of fillers, glass fibers, and reinforcing agents, and mixtures of the aforementioned additives. The additive content of the aqueous sol-gel composition (II) employed in accordance with the invention may vary very widely according to the end use. The amount, based in each case on the total weight of the aqueous sol-gel composition (II) employed in accordance with the invention, is preferably 0.1 to 10.0 wt %, more preferably 0.1 to 8.0 wt %, very preferably 0.1 to 6.0 wt %, especially preferably 0.1 to 4.0 wt %, and more particularly 0.1 to 2.0 wt %, and mixtures thereof.

The fractions in wt % of all of the components and additives present in the aqueous sol-gel composition (II) employed in accordance with the invention add up preferably to a total of 100 wt %, based on the total weight of the composition.

### Step (2a)

In one preferred embodiment, the process of the invention further comprises a step (2a), which preferably follows step (1) or (2), more preferably step (2), but is carried out before an optional step (3), namely

(2a) rinsing the substrate obtainable by step (2), contacted with the aqueous sol-gel composition (II) and coated at least partly with the coating composition (I), with water and/or ultrafiltrate.
Step (2a-1)

In one preferred embodiment, the process of the invention further comprises a step (2a-1), which preferably follows step (2) or step (2a) or else is carried out after step (1) and before step (2), but in each case before an optional step (3), namely
(2a-1) contacting the substrate obtained by step (1), and optionally subjected to contacting as per step (2), and coated at least partly with the autophoretically deposited coating composition, with an aqueous aftertreatment composition (NA),
where the aqueous aftertreatment composition (NA) comprises
(NA1) at least one water-soluble compound which comprises at least one Ti atom and/or at least one Zr atom, and
(NA2) at least one water-soluble compound as source of fluoride ions, comprising at least one fluorine atom, or
where the aqueous aftertreatment composition (NA) comprises
(NA3) at least one water-soluble compound which is obtainable by reaction of at least one water-soluble compound comprising at least one Ti atom and/or at least one Zr atom with at least one water-soluble compound as source of fluoride ions that comprises at least one fluorine atom.

The at least one Ti atom and/or the at least one Zr atom preferably have the +4 oxidation state. On the basis of the components it comprises, and preferably, moreover, on the basis of the appropriately selected proportions of these components, the aqueous aftertreatment composition preferably comprises a fluoro complex such as, for example, a hexafluorometallate, i.e., in particular, hexafluorotitanate and/or at least one hexafluorozirconate. The aftertreatment composition preferably has a total concentration of the elements Ti and/or Zr of not less than 2.5.10⁻⁴ mol/L but not more than 2.0·10⁻² mol/L. The preparation of such compositions is known from WO 2009/115504 A1, for example. The aftertreatment composition (NA) is preferably an aqueous solution which comprises hexafluorozirconic acid or a corresponding salt of said acid.

The aftertreatment composition preferably further comprises copper ions, preferably copper(II) ions, and also, optionally, one or more water-soluble and/or water-dispersible compounds comprising at least one metal ion selected from the group consisting of Ca, Mg, Al, B, Zn, Mn, and W, and also mixtures thereof, preferably at least one aluminosilicate, and more particularly one in which the atomic ratio of Al to Si atoms is at least 1:3. The aluminosilicates take the form preferably of nanoparticles having a particle size, as determinable by dynamic light scattering, in the range from 1 to 100 nm. The particle size of such nanoparticles as determinable by dynamic light scattering in the range from 1 to 100 nm is determined here in accordance with DIN ISO 13321 (date: Oct. 1, 2004).

An object of the present invention, however, is that it be possible to do without any such aftertreatment of the substrate for at least partial coating, by means of an aqueous solution which comprises hexafluorozirconic acid or a corresponding salt of said acid. In one preferred embodiment, therefore, the process of the invention does not comprise a step (2a-1).

The aqueous aftertreatment composition (NA) used in the optional step (2a-1) preferably has a temperature in the range from 8° C. to 80° C., more preferably in the range from 10° C. to 75° C., very preferably in the range from 12° C. to 70° C., especially preferably in the range from 14° C. to 68° C., more particularly in the range from 15° C. to 66° C. or in the range from 15° C. to 64° C., more preferably still in the range from 17° C. to 62° C., most preferably in the range from 18° C. to 60° C. In another preferred embodiment, the aqueous aftertreatment composition (NA) used in step (2a) of the process of the invention has a temperature in a range from 20° C. to 80° C., more preferably in the range from 30° C. to 75° C., very preferably in the range from 40° C. to 70° C., especially preferably in the range from 50° C. to 65° C.

Where the aqueous sol-gel composition used in step (2) of the process of the invention has a temperature >30° C., such as, for example, in a range from >30° C. to 70° C., preferably >40° C., such as, for example, in a range from >40° C. to 70° C., more preferably >50° C., such as, for example, in a range from >50° C. to 70° C., the aqueous aftertreatment composition (NA) used in the optional step (2a-1) preferably has a temperature in a range from 8° C. to 30° C., preferably in a range from 10° C. to 28° C., more preferably in a range from 15° C. to 25° C. or 18 to 23° C.

Where the aqueous sol-gel composition used in step (2) of the process of the invention has a temperature <50° C., preferably <40° C., more preferably <30° C., more particularly a temperature in a range from 8° C. to 30° C. or 10° C. to 28° C. or 15° C. to 25° C. or 18 to 23° C., the aqueous aftertreatment composition (NA) used in the optional step (2a-1) preferably has a temperature >30° C., such as, for example, in a range from >30° C. to 70° C., preferably >40° C., such as, for example, in a range from >40° C. to 70° C., more preferably >50° C., such as, for example, in a range from >50° C. to 70° C.

Step (2a-2)

In one preferred embodiment, the process of the invention further comprises a step (2a-2), which preferably follows step (2) or step (2a) or step (2a-1), but is carried out in each case before an optional step (3), namely
(2a-2) contacting, with water, the substrate obtained by step (1), subjected to contacting as per step (2), and coated at least partly with the autophoretically deposited coating composition.

The water used in the optional step (2a-2) preferably has a temperature in the range from 8° C. to 80° C., more preferably in the range from 10° C. to 75° C., very preferably in the range from 12° C. to 70° C., especially preferably in the range from 14° C. to 68° C., more particularly in the range from 15° C. to 66° C. or in the range from 15° C. to 64° C., more preferably in the range from 17° C. to 62° C., most preferably in the range from 18° C. to 60° C.

In another preferred embodiment the water used in step (2a-2) of the process of the invention has a temperature in a range from 20° C. to 80° C., more preferably in the range from 30° C. to 75° C., very preferably in the range from 40° C. to 70° C., especially preferably in the range from 50° C. to 65° C., more particularly when the aqueous sol-gel composition used in step (2) of the process of the invention has a temperature <50° C., preferably <40° C., more preferably <30° C., more particularly a temperature in a range from 8° C. to 30° C. or 10° C. to 28° C. or 15° C. to 25° C. or 18 to 23° C. and/or the aqueous aftertreatment composition (NA) used in the optional step (2a-1) has a temperature <50° C., preferably <40° C., more preferably <30° C., more particularly a temperature in a range from 8° C. to 30° C. or 10° C. to 28° C. or 15° C. to 25° C. or 18 to 23° C.

### Step (2b)

The process of the invention optionally further comprises at least one step (2b), which preferably follows step (2) and/or (2a) and/or (2a-1) and/or (2a-2), but is preferably carried out before an optional step (3), namely
(2b) applying at least one further coating film to the substrate obtainable by step (2) and/or (2a) and/or (2a-1) and/or (2a-2), contacted with the aqueous sol-gel composition (II), and coated at least partly with the coating composition (I).

By means of the step (2b) it is possible for one or more further coating films to be applied to the substrate obtainable by step (2) or by steps (2) and (2a) and optionally (2a-1) and/or (2a-2), contacted with the aqueous sol-gel composition (II), and coated at least partly with the coating composition (I); the one or more further coating films are applied at least to the coating composition (I) treated as per step (2) and deposited autophoretically as per step (1). Where two or more coats are to be applied, step (2b) may be repeated the corresponding number of times. Examples of further coating films for application are, for example, basecoat films, surfacer films and/or single-coat or multicoat topcoat films. A powder coating film can also be applied. In this case the autophoretically deposited coating composition (I), after the contacting as per step (2) and after optional rinsing with water and/or ultrafiltrate (as per step (2a)), can be cured, this curing taking place preferably, as described hereinafter, in accordance with a step (3), before a further coat such as a surfacer coat and/or a single-coat or multicoat topcoat is applied. Alternatively, however, the autophoretically deposited coating composition (I), after contacting as per step (2) and after an optional rinse with water and/or ultrafiltrate as per step (2a), may not be cured; instead, a further coat such as a surfacer coat and/or a single-coat or multicoat topcoat may be initially applied (“wet-on-wet” method). In this case, following application of this further coat or coats, the resulting system as a whole is cured, with this curing taking place, as described below, in accordance with a step (3).

Step (2b) of the process of the invention is carried out in particular for those metallic substrates which are used in the automobile industry, such as bodies and parts thereof, for example. For substrates from which components or articles are produced, such as components of electrical household products or components from the sector of appliance casing, façade paneling, ceiling paneling, window profiles, furniture parts or automotive interior parts, step (2b) is preferably not carried out or, if at all, in a step (2b) of this kind a powder coating film is applied to the substrate obtainable by step (2) or by steps (2) and (2a), contacted with the aqueous sol-gel composition (II), and coated at least partly with the coating composition (I).

### Step (3)

In one preferred embodiment, the process of the invention further comprises at least one step (3), which preferably follows step (2) or steps (2) and (2a), and also in each case follows optionally (2a-1) and/or (2a-2) and/or (2b), namely
(3) full curing of the at least partial coating on the substrate, obtained by step (2) or by steps (2) and (2a) and also optionally (2a-1) and/or (2a-2), and also, in each case, optionally, by at least one step (2b).

Step (3) of the process of the invention is carried out preferably by baking after step (2) and optionally after at least one further step (2a) and/or (2a-1) and/or (2a-2) and/or (2b). Step (3) takes place preferably in an oven. Full curing in this case takes place preferably at an oven temperature in the range from 140° C. to 200° C., more preferably in a range from 150° C. to 190° C., very preferably in a range from 160° C. to 180° C.

### At Least Partly Coated Substrate

The present invention further relates to an at least partly coated metallic substrate obtainable by the process of the invention, such as an at least partly coated metal strip. The present invention further relates to an article or component produced from one such at least partly coated substrate. Components or articles of this kind may be, for example, bodies and parts thereof of vehicles such as automobiles, trucks, motorcycles, and buses, and components of electrical household products, or else components from the area of appliance paneling, façade paneling, ceiling paneling, or window profiles. Furthermore, the components or articles in question may be those for household appliances, furniture parts, automotive interior parts such as seat frames, for example.

At least partly coated metallic substrates which are produced by the process of the invention preferably have, at the upper boundary of the autophoretically deposited coating composition (I), a region in which metal atoms and/or semimetal atoms present in the aqueous sol-gel composition (II) used are present at greater concentration, this accumulation of atoms being detectable on the surface and/or in the cross section by energy-dispersive X-ray spectroscopy (EDX), or on the surface by X-ray photoelectron spectroscopy (XPS).

Particularly preferred at least partly coated metallic substrates obtainable by the process of the invention are substrates which consist at least partly of aluminum, zinc, or galvanized metals.

### Use

A further subject of the present invention is a use of an aqueous sol-gel composition (II) for aftertreating a coating composition applied at least partly to a substrate by autophoretic deposition, by contacting of the autophoretically deposited coating composition with the aqueous sol-gel composition (II).

All preferred embodiments described hereinabove in connection with the use of the aqueous sol-gel composition (II) used in step (2) of the process of the invention are also preferred embodiments of the aqueous sol-gel composition with respect to its use for the aforementioned aftertreatment. The same applies to all preferred embodiments described hereinabove in connection with the use of the coating composition (I) used in step (1) of the process of the invention, and, furthermore, to all process steps stated in connection with the process of the invention.

### Methods of Determination

VDA alternating climate test to VDA 621-415 [VDA=German automaker association]

This alternating climate test (climatic cycling test) is used for determining the corrosion resistance of a coating on a substrate. The alternating climate test is carried out for hot-dip-galvanized steel (HDG) as the substrate coated accordingly. The alternating climate test is carried out in 6 cycles. One cycle here consists of a total of 168 hours (1 week) and encompasses
a) 24 hours of salt spray mist testing as per DIN EN ISO 9227 NSS (date: Sep. 1, 2012),
b) followed by 8 hours of storage including warming as per DIN EN ISO 6270-2 of September 2005, AHT method,
c) followed by 16 hours of storage including cooling as per DIN EN ISO 6270-2 of September 2005, AHT method,
d) 3-fold repetition of b) and c) (hence in total 72 hours), and
e) 48 hours of storage, including cooling, with vented climatic chamber as per DIN EN ISO 6270-2 of September 2005, AHT method.

If, still prior to the performance of the alternating climate test, the respectively baked coating on the samples under investigation is scored down to the substrate with a blade incision, the samples can be investigated for their level of undermining as per DIN EN ISO 4628-8 (date: Mar. 1, 2013), since the substrate corrodes along the score line during the performance of the alternating climate test. As a result of the progressive process of corrosion, the coating is undermined to a greater or lesser extent during the test. The extent of undermining in [mm] is a measure of the resistance of the coating.

The examples which follow serve to elucidate the invention, but should not be interpreted restrictively.

Unless noted otherwise, the percentages are always weight percentages.

### INVENTIVE AND COMPARATIVE EXAMPLES

### 1. Production of Inventively Used Aqueous Sol-Gel Compositions

### Aqueous Sol-Gel Composition S1

A mixture of tetraethoxysilane (TEOS), methyltriethoxysilane (MTEOS), 3-glycidylpropyltri-methoxysilane (GLYMO), deionized water, and formic acid (85 wt %) is stirred at room temperature (18-23° C.) for 24 hours. Thereafter the mixture is admixed with 3-aminopropyltriethoxysilane (AMEO) with stirring, and stirring is continued at room temperature for a further 24 hours. This gives a clear, slightly yellowish solution having a pH of 4.5.

### Aqueous Sol-Gel Composition S2

A mixture of tetraethoxysilane (TEOS), methyltriethoxysilane (MTEOS), and 3-glycidylpropyl-trimethoxysilane (GLYMO) is admixed with ethanol (to which 1 wt % of deionized water is added, based on the total weight of the ethanol used) and also with zirconium tetrabutoxide (80% in butanol), with stirring. After stirring has been carried out for 15 minutes at room temperature (18-23° C.), a peristaltic pump is used (at a pumping speed of 0.694 ml/min) to add deionized water, adjusted beforehand to a pH of 4.0 using phosphoric acid, to this mixture. The resulting solution is stirred at room temperature (18-23° C.) for 24 h.

Table 1 gives an overview of the aqueous sol-gel compositions S1 and S2:

TABLE 1

| Sol-gel composition | S1 | S2 |
|---|---|---|
| TEOS/wt % | 0.31 | 0.327 |
| MTEOS/wt % | 0.31 | 0.327 |
| GLYMO/wt % | 0.31 | 0.327 |
| Zirconium tetrabutoxide (80% in butanol)/ | — | 0.079 |
| wt % | | |
| Deionized water/wt % | 98.93 | — |
| Formic acid (85 wt %)/wt % | 0.04 | — |
| Deionized water (adjusted to pH of 4.0 | — | 97.94 |
| with phosphoric acid)/wt % | | |
| Ethanol (admixed with 1 wt % deionized | — | 1.0 |
| water)/wt % | | |
| AMEO/wt % | 0.10 | — |
| Solids content/wt % | 0.50 | 0.50 |

The wt % figures are based in each case on the total weight of the aqueous sol-gel composition.

### 2. Production of an Inventively Used Autophoretically Depositable Coating Composition

An inventively used autophoretically depositable coating composition (AU1) is produced in analogy to a production method known to the skilled person from US 2004/043155 A1 (cf. example 6 from US 2004/043155 A1).

This method involves mixing an epoxide-based polymer resin together with a monomer mixture comprising n-butyl (meth)acrylate, (meth)acrylic acid, methyl (meth)acrylate, isobornyl (meth)acrylate, styrene, and a hydroxyalkyl (meth)acrylate in the presence of at least one organic solvent, more particularly at least one alcohol, and also with a blocked isocyanate crosslinking agent and, optionally, further additives such as chain transfer agents typically used in an emulsion polymerization, and also at least one anionic surfactant in solution in water, to give a water-in-oil emulsion. This water-in-oil emulsion is stirred for a period of 5 minutes and then transferred to a fluidizer (reaction chambers H210Z and H230Z), in which it is homogenized three times at 700 bar. The resulting miniemulsion is subsequently heated to 75° C. Added dropwise to the resulting mixture at this temperature is an initiator solution, using an infusion pump, at a stirring speed of 180 rpm. For an amount of about 1 L of miniemulsion, the rate of dropwise addition is 20 ml/h. Initiator used is tert-butyl hydroperoxide, in combination with sodium formaldehyde-sulfoxylate as reducing agent. After the dropwise addition has been ended, cooling takes place to 18 to 23° C., followed by stirring for 16 h to give an aqueous minidispersion.

1260 g of deionized water are introduced as an initial charge, to which are added in succession and with stirring 202 g of the aqueous minidispersion obtained as described above, 98 g of the Autophoretic Starter 300 product available commercially from Henkel, 10 g of an activator such as, for example, the commercially available product Activator 35 from Henkel, which is diluted hydrofluoric acid, 10 g of a depolarizing agent such as H₂O₂ or bronopol, for example, and a further 420 g of deionized water. The mixture which results accordingly is aged without covering for 24 h with stirring. Any water evaporated during this aging is made up again with deionized water and the resulting mixture is used as coating composition (AU1).

### 3. Production of Coated Metallic Substrates by the Inventive Method (Inventive Examples B1a, B1b, B2a, and B2b) and by a Comparative Method (Comparative Examples C1a, C1b, C2a, and C2b; without Step (2) of the Inventive Method)

Two kinds of a total of 16 metal test sheets T1 (hot-dip-galvanized steel (HDG)) and T2 (aluminum AA6014 (ALU)) are used as examples of metallic substrates (T1 and T2 each eight times).

These metal test sheets are cleaned in each case by immersion into a bath containing an aqueous solution comprising the commercially available products Ridoline 1565-1 (3.0 wt %) and Ridosol 1400-1 (0.3 wt %) from Henkel and also water (96.7 wt %) over a period of 1.5 minutes at a temperature of 60° C. This is followed by mechanical cleaning (by means of brushes), after which the metal sheets are again immersed into the bath for a period of 1.5 minutes.

The substrates cleaned in this way are subsequently rinsed with water (for a period of 1 minute) and with deionized water (for a period of 1 minute).

Immediately after the cleaning, an autophoretically depositable coating material is applied to each of the cleaned metal test sheets T1 and T2, by immersion of the respective sheet in each case into a corresponding dip coating bath containing an autophoretically depositable coating composition. This dip coating bath has a bath temperature of 30° C. The immersion time is 90 seconds in each case. The autophoretically depositable coating composition used in each case is the coating composition (AU1).

The substrates coated in this way are rinsed with deionized water (step (1a) of the method).

Thereafter, two each of the substrates T1 and T2 coated with the coating material are immersed into a bath of the aqueous sol-gel composition S1 for a period of 1 minute at a bath temperature of 60° C. (step (2); inventive examples B1a and B1b). Analogously, two each of the substrates T1 and T2 coated with the coating material are immersed into a bath of the aqueous sol-gel composition S2 for a period of 1 minute at a bath temperature of 60° C. (step (2); inventive examples B2a and B2b). Furthermore, two each of the substrates T1 and T2 coated with the coating material are immersed into a bath of deionized water for a period of 1 minute at a bath temperature of 60° C. (comparative examples C1a and C1b). In addition, two each of the substrates T1 and T2 coated with the coating material are immersed into a bath which comprises the commercially available product Aquence® E2 Reaction Rinse from Henkel, for a period of 1 minute at a bath temperature of 60° C., the latter product being an aqueous solution comprising hexafluorozirconic acid and ammonium hexafluorozirconate (comparative examples C2a and C2b).

This is followed in each case by rinsing with deionized water for a period of 1 minute (step (2a)). The substrate obtained after step (2) here is immersed into a bath of deionized water at room temperature (18-23° C.).

The coatings obtained accordingly are subsequently baked in each case at 180° C. (oven temperature) over a period of 25 minutes.

Tables 2a and 2b provide an overview of the coated substrates obtained by the inventive method and the comparative methods. Each of examples B1a, B1b, B2a, B2b, C1a, C1b, C2a, and C2b was produced twice, as evident from the aforementioned number of metal test sheets used, in order for a duplicate determination to be carried out as described in section 4, below.

TABLE 2a

| | Inventive | Inventive | Inventive | Inventive |
|---|---|---|---|---|
| | example B1a | example B1b | example B2a | example B2b |
| Substrate | T1 (HDG) | T2 (ALU) | T1 (HDG) | T2 (ALU) |
| Sol-gel | S1 | S2 | S1 | S2 |
| composition | | | | |
| used in | | | | |
| step (2) | | | | |

TABLE 2b

| | Comparative | Comparative | Comparative | Comparative |
|---|---|---|---|---|
| | example C1a | example C1b | example C2a | example C2b |
| Substrate | T1 (HDG) | T2 (ALU) | T1 (HDG) | T2 (ALU) |

In the case of comparative examples C1a and C1b, as described above, instead of the implementation of step (2) of the inventive method, the substrate coated with the coating material is contacted with deionized water and, in the case of C2a and C2b, with the commercially available fluoride-containing product Aquence® E2 Reaction Rinse.

### 4. Investigation of the Corrosion Control Effect of the Coated Substrates of Inventive Examples B1a and B2a and Comparative Examples C1a and C2a

All of the tests below were carried out in accordance with the method of determination indicated above and with the corresponding standard. Each value in table 3 below is the average value from a duplicate determination.

TABLE 3

| | Inventive | Inventive | Comparative | Comparative |
|---|---|---|---|---|
| | example B1a | example B2a | example C1a | example C2a |
| Undermining | 1.7 | 2.1 | 3.8 | 2.6 |
| [mm] as per | | | | |
| DIN EN ISO | | | | |
| 4628-8 after | | | | |
| 6 cycles of a | | | | |
| VDA* climatic | | | | |
| cycling test | | | | |
| according to | | | | |
| VDA* 621-415 | | | | |

*VDA = German Automaker Association

As is evident from table 3, the coated substrates produced by the inventive method, those of inventive examples B1a and B2a, are notable in particular, in comparison to comparative examples C1a and C2a, for the fact that the undermining in [mm] after implementation of the VDA climatic cycling test is substantially less.

1: A method for at least partly coating a metallic substrate, comprising:
(1) at least partly coating a metallic substrate with an autophoretically depositable coating composition (I), and
(2) contacting the metallic substrate at least partly coated with the autophoretically deposited coating composition (I) with an aqueous composition,
wherein the aqueous composition of said (2) contacting is an aqueous sol-gel composition (II).

2: The method as claimed in claim 1, wherein said (2) contacting is carried out before curing of the autophoretically deposited coating composition.

3: The method as claimed in claim 1, wherein the aqueous sol-gel composition (II) of said (2) contacting is obtainable by reacting
at least one starting compound, which has at least one metal atom, at least one semimetal atom, or a combination thereof, and at least two hydrolyzable groups, and which optionally further has at least one nonhydrolyzable organic radical,
with water.

4: The method as claimed in claim 1, wherein the aqueous sol-gel composition (II) of said (2) contacting is obtainable by reacting
(M¹)^{x}(X¹)ₐ(R¹), (A1)
(M²)^{y}(X²)_{b}(R²)(R³), (A2)
or a combination of (A1) and (A2),
with water, where
M¹ and M² each independently of one another are a metal atom or a semimetal atom,
X¹ and X² each independently of one another are a hydrolyzable group,
x is the valence of the metal atom or semimetal atom M¹,
y is the valence of the metal atom or semimetal atom M²,
R¹ is X¹, a nonhydrolyzable organic radical, is (T)(M¹)^{x}(X¹)_{c} or is (U)[(M¹)^{x}(X¹)_{c}]₂,
R² is a nonhydrolyzable organic radical,
R³ is a nonhydrolyzable organic radical, is (T)(M¹)^{x}(X¹)_{c}, is (U)[(M¹)^{x}(X¹)_{c}]₂, is (V)(M²)^{y}(X²)_{d}(R²) or is (W)[(M²)^{y}(X²)_{d}(R²)]₂,
a is x if R¹ is X¹ or
a is x−1 if R¹ is a nonhydrolyzable organic radical, is (T)(M¹)^{x}(X¹)_{c} or is (U)[(M¹)^{x}(X¹)_{c}]₂, in each case with the proviso that a is at least 2,
b is y−2,
with the proviso that b is at least 2,
T, U, V, and W, in each case independently of one another, are each a radical having 1 to 30 carbon atoms and able optionally to have up to 10 heteroatoms and heteroatom groups selected from the group consisting of O, S, and N,
c is x−1, and
d is y−2.

5: The method as claimed in claim 4, wherein
X¹ and X² each independently of one another are selected from the group consisting of a halide and an alkoxy group represented by O—R^{a}, where R^{a} in each case is a C₁₋₁₆ aliphatic radical, and
M¹ and M² each independently of one another are selected from the group consisting of Al, Ti, Zr, Fe, B, and Si.

6: The method as claimed in claim 4, wherein the at least one nonhydrolyzable organic radical within the definitions of R¹, R², and R³, in each case independently of one another, is a radical selected from the group consisting of a C₁-C₁₀ aliphatic radical, a C₁-C₁₀ heteroaliphatic radical, a C₁-C₁₀ cycloaliphatic radical, a 3-10-membered heterocycloaliphatic radical, a 5-12-membered aryl radical, a 5-12-membered heteroaryl radical, a C₃-C₁₀ cycloaliphatic radical bonded via a C₁₋₆ aliphatic radical, a 3-10-membered heterocycloaliphatic radical bonded via a C₁₋₆ aliphatic radical, a 5-12-membered aryl or heteroaryl radical bonded via a C₁₋₆ aliphatic radical,
wherein each radical optionally comprises at least one reactive functional group.

7: The method as claimed in claim 4, wherein
the aqueous sol-gel composition (II) of said (2) contacting is obtainable by reacting, with water, at least one compound (A1) in which R¹ is a nonhydrolyzable organic radical which has at least one reactive functional group selected from the group consisting of a primary amino group, a secondary amino group, an epoxide group, a thiol group, an isocyanate group, a phosphorus-containing group, and a group which has an ethylenically unsaturated double bond,
and, optionally, at least one further compound (A1) in which R¹ is X¹,
and, optionally, at least one further compound (A1) in which R¹ is a nonhydrolyzable organic radical which has no reactive functional groups.

8: The method as claimed in claim 4, wherein the aqueous sol-gel composition (II) of said (2) contacting is obtainable by reacting
at least one compound Si(X¹)₃(R¹) as at least one compound (A1),
where R¹ is a nonhydrolyzable organic radical which has at least one reactive functional group selected from the group consisting of a primary amino group, a secondary amino group, an epoxide group, and a group which has an ethylenically unsaturated double bond,
and, optionally, at least one compound Si(X¹)₄ as at least one further compound (A1),
and, optionally, at least one compound Si(X¹)₃(R¹) as at least one further compound (A1), where R¹ is a nonhydrolyzable organic radical which has no reactive functional group,
and, optionally, at least one compound Zr(X¹)₄ as at least one further compound (A1),
with water.

9: The method as claimed in claim 4, wherein the aqueous sol-gel composition (II) of said (2) contacting is obtainable by reacting
at least one compound Si(X¹)₃(R¹) as at least one compound (A1),
where R¹ therein is a nonhydrolyzable C₁-C₁₀ aliphatic organic radical which has at least one epoxide group as reactive functional group,
optionally, at least one compound Si(X¹)₃(R¹) as at least one further compound (A1),
where R¹ therein is a nonhydrolyzable C₁-C₁₀ aliphatic organic radical which has at least one reactive functional group selected from the group consisting of a primary amino group and a secondary amino group,
at least one compound Si(X¹)₄ as at least one further compound (A1),
and at least one compound Si(X¹)₃(R¹) as at least one further compound (A1),
where R¹ therein is a nonhydrolyzable organic C₁-C₁₀ aliphatic radical which has no reactive functional group,
and, optionally, at least one compound Zr(X¹)₄ as at least one further compound (A1),
with water.

10: The method as claimed in claim 3, wherein the solids content of the aqueous sol-gel composition (II) of said (2) contacting, after hydrolysis and condensation of the at least one starting compound operable for preparing the aqueous sol-gel composition (II), is in a range from 0.01 to 10 wt %, based on the total weight of the aqueous sol-gel composition.

11: The method as claimed in claim 1, wherein the aqueous sol-gel composition (II) of said (2) contacting has a pH in the range from 3.0 to 6.0.

12: The method as claimed in claim 1, which further comprises
(3) fully curing the at least partial coating, obtained according to said (1) at least partly coating and subjected to contacting as per said (2) contacting, on the substrate.

13: An at least partly coated substrate obtainable by the method as claimed in claim 1.

14: A component or article comprised of at least one, at least partly coated substrate as claimed in claim 13.

15. (canceled)

16: A method for aftertreating a coating composition at least partly present on a metallic substrate, comprising:
(1) at least partly coating a metallic substrate with an autophoretically depositable coating composition (I), and
(2) contacting the autophoretically deposited coating composition (I), which is at least partly present on said metallic substrate, with an aqueous composition,
wherein the aqueous composition of said (2) contacting is an aqueous sol-gel composition (II).
